(19) United States
(12) Patent Application Publication
(10) Pub. No.: US 2024/0180262 A1
(43) Pub. Date: Jun. 6, 2024

(54) A Charging Case

(71) Applicant: Nicoventures Trading Limited, LONDON (GB)

(72) Inventors: Sam LAI, London (GB); Ping Chou CHEN, London (GB); Mohsin MASIH-UD-DIN, London (GB)

(21) Appl. No.: 18/564,186

(22) PCT Filed: May 25, 2022
(86) PCT No.: PCT/GB2022/051327

§ 371 Date: Nov. 27, 2023

(30) Foreign Application Priority Data
May 27, 2021 (GB) 2107603.9

(51) Int. Cl. A24F 40/95; A24F 40/40; H02J 7/00

(52) U.S. Cl. CPC A24F 40/95; A24F 40/40; H02J 7/0045

(57) ABSTRACT

A charging case for an aerosol provision system includes a charging connector and a ramp. The charging connector is configured to removably connect to a component of the aerosol provision system. The ramp is arranged such that when the component is moved in a direction away from the charging connector a part of the aerosol provision system moves along the ramp. A charging case for an aerosol provision system including a charging connector and a recess. The charging connector is configured to removably connect to a component of the aerosol provision system and the recess is arranged such that when the component has been disconnected from the charging connector a portion of the component can enter the recess to allow the component to rotate relative to the charging case. A kit of parts can include a charging case and an aerosol delivery system.

### PRIORITY CLAIM

The present application is a National Phase entry of PCT Application No. PCT/GB2022/051327, filed May 25, 2022, which claims priority from GB Application No. 2107603.9, filed May 27, 2021, each of which hereby is fully incorporated herein by reference.

### TECHNICAL FIELD

The present disclosure relates to a charging case for an aerosol delivery system and a kit of parts comprising a charging case and an aerosol delivery system.

### BACKGROUND

Smoking articles, such as cigarettes, cigars and the like burn tobacco during use to create tobacco smoke. Attempts have been made to provide alternatives to these articles by creating products that release compounds without combusting. For example, tobacco heating devices heat an aerosol provision substrate such as tobacco to form an aerosol by heating, but not burning, the substrate. An aerosol delivery device may be provided with a case, such as a carry case, for retaining the device when not in use. There remains a need for further developments in this field.

### SUMMARY

In a first aspect, there is provided a charging case for an aerosol provision system, the charging case comprising: a charging connector configured to removably connect to a component of the aerosol provision system; and, a ramp arranged such that when the component is moved in a direction away from the charging connector a part of the aerosol provision system moves along the ramp.

In some embodiments, the charging case comprises a storage area for receiving the aerosol provision system and, preferably, wherein the storage area is a cavity in the charging case.

In some embodiments, the ramp is located at an end of the storage area that is distal to the charging connector.

In some embodiments, the charging case has a first surface and the storage area extends into the first surface and, preferably, wherein the ramp extends to the first surface.

In some embodiments, the first surface is generally planar. In some embodiments, the first surface is a top surface. For example, the first surface may be a top surface of the main body.

In some embodiments, at least a portion of the ramp follows a substantially linear path.

In some embodiments, at least a portion of the ramp follows a substantially curved path.

In some embodiments, the ramp has a length of at least 0.6 mm and, preferably, at least 0.7 mm, 0.8 mm, 0.9 mm or 1 mm.

In some embodiments, the charging case comprises a body and a lid, wherein the body or lid comprises the ramp.

In some embodiments, said part of the aerosol delivery system is the component of the aerosol delivery system or is a further component of the aerosol delivery system.

In some embodiments, the aerosol delivery system comprises an aerosol delivery device and, preferably, wherein the entire aerosol delivery device is moved in the direction away from the charging connector.

In some embodiments, at least a portion of the ramp extends at an angle of at least 45 degrees relative to a central axis of the power connector in a direction away from the power connector, and preferably, at an angle of at least 50, 60, 70, 75, 80, 85, 86 or 87 degrees.

In some embodiments, at least a portion of the ramp extends at an angle of at most 89 degrees relative to a central axis of the power connector in a direction away from the power connector, and preferably, at an angle of at most 88 or 87 degrees.

In some embodiments, the ramp is arranged such that said part of the aerosol delivery system only moves along the ramp once the component has been disconnected from the power connector and, preferably, only when the component is spaced from the power connector.

In some embodiments, the ramp is configured to lift said part of the aerosol delivery system out of the charging case when said part moves along the ramp.

In some embodiments, the charging case comprises one or more formations that are configured to space at least a portion of the aerosol provision system from the charging case to provide an air gap.

In some embodiments, at least one formation is provided in proximity to the ramp such that said part of the aerosol delivery system moves from the at least one formation and on to the ramp.

In some embodiments, the or each formation is arranged such that at least one formation is in contact with the aerosol delivery system at all times from when the component is disconnected from the power connector until said part of the aerosol delivery system contacts the ramp.

In some embodiments, the ramp is arranged such that when the component is slid in the direction away from the charging connector the part of the aerosol provision system moves along the ramp.

In some embodiments, the ramp is integrally formed with the body or lid. In other embodiments, the ramp is attached to the body or lid.

In some embodiments, the ramp comprises first and second ramp portions. The first and second ramp portions may extend substantially parallel to each other. In some embodiments, each of the first and second ramp portions may be arranged to contact a corresponding part of the aerosol delivery system, for example, a corresponding corner of the aerosol delivery system when the component is moved away from the power connector.

In some embodiments, the one or more formations are protrusions.

In some embodiments, the one or more formations project out of a surface of the charging case.

In some embodiments, the or each formation comprises a rib and, preferably, the or each rib is straight or substantially straight.

In some embodiments, charging case has a surface configured to underlie the aerosol delivery system when the aerosol delivery system is located in the charging case for charging, wherein the or each formation is provided over less than 20% and, preferably, less than 15%, less than 10% or less than 5% of the surface area of the surface and, preferably, wherein the surface is a planar surface.

In some embodiments, the total surface contact area of the or every formation with the aerosol delivery system when the aerosol delivery system is located in the charging case for charging is at most 400 millimeters squared and, preferably, at most 300, 250, 200, 150, 125 or 100 millimeters squared.

In some embodiments, the or each formation extends longitudinally.

In some embodiments, the or each formation has a length in the range at least 40 mm and, preferably, at least 60, 80, 100 or 120 mm.

In some embodiments, the or each formation has a height in the range of 0.1 to 1 mm and, preferably, in the range of 0.1 to 0.5 mm and, preferably, in the range of 0.2 to 0.3 mm.

In some embodiments, the or each formation has a width in the range of 0.5 to 2 mm and, preferably, in the range of 0.5 to 0.8 mm and, preferably, in the range of 0.6 to 0.7 mm.

In some embodiments, the charging case comprises a plurality of formations that provide the air gap.

In some embodiments, the charging case comprises in the range of two to ten formations and, preferably, in the range of three to five formations.

In some embodiments, the formations extend substantially in parallel to each other.

In some embodiments, the formations are discrete and spaced from each other.

In some embodiments, the formations are integrally formed with the main body and/or lid of the charging case. In some embodiments, the formations are provided in regular rows and/or regular columns.

In some embodiments, the or each formation has a generally convex cross-section and, preferably, the cross-sectional shape of the or each formation is generally curved.

In some embodiments, the charging case comprises a storage area configured to receive the aerosol delivery system and, preferably, the storage area is a cavity.

In some embodiments, at least one formation is provided in the storage area.

In some embodiments, one or more formations that are configured to space at least a portion of the aerosol provision system from the charging case to provide an air gap when the aerosol provision system is connected to the port.

In some embodiments, at least one formation is provided proximate the port.

In some embodiments, at least one formation is arranged such that the formation is in contact with the aerosol delivery system when the aerosol delivery system is connected to the port.

In some embodiments, the or each formation is arranged such that at least one formation is in contact with the aerosol delivery system at all times from when the aerosol delivery system is disconnected from the port until the aerosol delivery system contacts the ramp.

In some embodiments, the charging case comprises a main body and a lid, wherein the main body and/or lid comprises the one or more formations.

According to the present disclosure, there is also provided a charging case for an aerosol provision system, the charging case comprising: a charging connector configured to removably connect to a component of the aerosol provision system; and, a recess arranged such that when the component has been disconnected from the charging connector a portion of the component can enter the recess to allow the component to rotate relative to the charging case.

In some embodiments, the charging connector is arranged such that the component can be slid relative to the charging connector to disconnect from the charging connector.

In some embodiments, the recess is arranged such that the component is moveable from a first position, wherein the component is connected to the charging connector, to a second position, wherein the component is disconnected from the charging connector and the component is rotated relative to the charging case to enter the recess.

In some embodiments, the recess is arranged such that when the component is in the first position, said portion of the component is out of alignment with the recess in the axial direction of the power connector, and when the component is in the second position, said portion of the component is aligned with the recess in the axial direction of the power connector.

In some embodiments, said portion of the component is disposed towards or at an end of the component.

In some embodiments, the recess is configured such that the component can rotate by at least 1 degree when the component enters the recess and, preferably, can rotate by at least 1.5, 2 or 2.5 degrees.

In some embodiments, the recess is configured such that the component rotates about an axis that is substantially perpendicular to the axial direction of the power connector to enter the recess.

In some embodiments, the charging case has a first surface and wherein the recess is configured such that the component can be moved to a position within the recess wherein a part of the aerosol delivery system protrudes from the first surface and, preferably, the first surface is generally planar.

In some embodiments, the first surface is a top surface. For example, the first surface may be a top surface of the main body.

In some embodiments, the recess is spaced from the power connector in the axial direction of the power connector and, preferably, is spaced from the power connector by a distance of less than 10 mm and, preferably, less than 9, 8, 7, 6 or 5 mm.

In some embodiments, the recess comprises a first ramp region configured such that the component can move along the first ramp region in a direction away from the power connector to move into the recess.

In some embodiments, at least a portion of the first ramp region extends at an angle of at least 5 degrees relative to the central axis of the power connector in a direction away from the power connector and, preferably, at least 10, 12, 14, 16 or 18 degrees.

In some embodiments, the first ramp region extends at a first angle of at most 45 degrees relative to the central axis of the power connector in a direction away from the power connector and, preferably, at most 30, 25, 20 or 18 degrees.

In some embodiments, at least a portion of the first ramp region follows a non-linear path and, preferably, is curved.

In some embodiments, the first ramp region is generally planar. The first ramp region may comprise a generally planar surface.

In some embodiments, the recess comprises a second ramp region.

In some embodiments, the second ramp region is configured such that the component can move along the second ramp region in a direction away from the power connector such that a part of the aerosol delivery device moves out of the charging case.

In some embodiments, at least a portion of the second ramp region extends at a second angle of at least 1 degrees relative to the axial direction of the power connector in a direction towards the power connector and, preferably, at least 1.5, 2 or 2.5 degrees.

In some embodiments, the first angle is different to the second angle and, preferably, is larger than the second angle.

In some embodiments, the second ramp region extends at an angle of at most 10 degrees relative to the central axis of the power connector in a direction towards the power connector and, preferably, at most 8, 6, 4, 3 or 2.5 degrees.

In some embodiments, at least a portion of the second ramp region follows a substantially linear path.

In some embodiments, the second ramp region is configured such that the component can lie against the second ramp region such that a part of the aerosol delivery device protrudes from the charging case.

In some embodiments, the first and second ramp regions are at an angle towards each other.

In some embodiments, the first ramp region is angled away from the power connector.

In some embodiments, the second ramp region is angled towards the power connector.

In some embodiments, the recess comprises an intermediate region that extends between the first and second ramp regions and, preferably, the intermediate region follows a generally linear path and, preferably, the generally linear path is substantially parallel to the axial direction of the power connector.

In some embodiments, the charging case comprises a ramp arranged such that when the component is slid in a direction away from the charging connector a part of the aerosol provision system moves along the ramp.

The ramp may have any of the features previously described.

In some embodiments, the second ramp region is configured such that the component can lie against the second ramp region such that a part of the aerosol delivery device abuts the ramp.

In some embodiments, the charging case is configured such that when the component is first disconnected from the power connector and rotated into the recess, the aerosol delivery system is spaced from the ramp, and wherein the component is then moved within the recess in a direction away from the power connector until the aerosol delivery system abuts the ramp.

In some embodiments, the charging case is configured such that when the aerosol delivery system abuts the ramp, the central axis of the aerosol delivery system is at an angle of greater than 0 degrees and less than 90 degrees relative to the central axis of the power connector and, preferably, is at an angle of at least 1 degree, and preferably, at least 1.5, 2 or 2.5 degrees.

In some embodiments, the charging case is configured such that when the aerosol delivery system abuts the ramp, the portion of the ramp that is abutted by the aerosol delivery system is at an angle of greater than 0 degrees and less than 90 degrees relative to the central axis of the power connector and, preferably, is at an angle of at least 45 degrees and preferably, at least 50, 60, 70, 75, 80, 85, 86 or 87 degrees.

In some embodiments, the charging case comprises one or more formations that are configured to space at least a portion of the aerosol provision system from the charging case to provide an air gap, and, preferably, wherein at least one formation is provided in the recess.

In some embodiments, the or each formation comprises a rib that extends through the recess such that the rib forms the first and second ramp portions. The rib may extend from proximate the power connector to proximate to the ramp.

In some embodiments, the charging case comprises a body and a lid, wherein the body or lid comprises the recess.

In some embodiments, the charging case comprises a storage area for receiving the aerosol provision system and, preferably, wherein the storage area is a cavity in the charging case.

In some embodiments, the recess is located in the storage area.

In some embodiments, the recess is arranged such that the aerosol delivery system overlies the recess when the component is connected to the power connector.

In some embodiments, said portion of the component is rounded or chamfered.

In some embodiments, the aerosol provision system comprises a front end that is remote to the power connector when the component is connected to the power connector and, preferably, wherein the front end is rounded or chamfered.

In some embodiments, the aerosol delivery system is an aerosol delivery device.

In some embodiments, the charging case further comprises the aerosol delivery system.

In some embodiments, the aerosol delivery system is configured to receive a removable article comprising an aerosolizable material and, preferably, wherein said aerosolizable material is present on a substrate.

In some embodiments, the aerosol delivery system in a non-combustible aerosol provision system and, preferably, comprises a tobacco heating system.

According to the present disclosure, there is also provided a kit of parts comprising a charging case according to the present disclosure and an aerosol delivery system.

In some embodiments, the kit of parts further comprises an article for use in the aerosol delivery system and, preferably, wherein the article is a removable article comprising an aerosol generating material.

### BRIEF DESCRIPTION OF THE DRAWINGS

Example embodiments will now be described, by way of example only, with reference to the following schematic drawings, in which:

FIG. 1 is a perspective view of an embodiment of a charging case for an aerosol delivery system, with a lid of the charging case in an open position;

FIG. 2 is a perspective view of the charging case of FIG. 1, with the lid in a closed position;

FIG. 3 is a perspective view of the charging case of FIG. 1, with an aerosol delivery system located in the charging case;

FIG. 4 is a top view of a base of the charging case of FIG. 1;

FIG. 5 is a cross-sectional side view of the base of the charging case of FIG. 1, taken along the line X-X shown in FIG. 4;

FIG. 6 is the same cross-sectional side view as FIG. 5, with the aerosol delivery system located in the charging case and connected to a power connector;

FIG. 7 is a cross-sectional side view of the base of the charging case of FIG. 1, taken along the line Y-Y shown in FIG. 4;

FIG. 8 is the same cross-sectional side view as FIG. 7, with the aerosol delivery system located in the charging case and connected to the power connector;

FIG. 9 is the same cross-sectional side view as FIG. 7, with the aerosol delivery system located in the charging case and disconnected from the power connector;

FIG. 10 is the same cross-sectional side view as FIG. 7, with the aerosol delivery system disconnected from the power connector and moved along a ramp of the charging case;

FIG. 11 is a block diagram of a non-combustible aerosol delivery device in accordance with an example embodiment;

FIG. 12 is a block diagram of a charging system of the charging case of FIG. 1;

FIG. 13 is a perspective view of a second embodiment of a charging case for an aerosol delivery system; and,

FIG. 14 is a perspective view of a third embodiment of a charging case for an aerosol delivery system;

FIG. 15 is a top view of a base of the charging case of FIG. 14;

FIG. 16 is a cross-sectional side view of the base of the charging case of FIG. 14, taken along the line Y-Y shown in FIG. 15

FIG. 17 is the same cross-sectional side view as FIG. 16, with the aerosol delivery system located in the charging case and connected to the power connector;

FIG. 18 is the same cross-sectional side view as FIG. 16, with the aerosol delivery system located in the charging case and moved to an intermediate position disconnected from the power connector;

FIG. 19 is the same cross-sectional side view as FIG. 16, with the aerosol delivery system disconnected from the power connector and an end of the system rotated into a recess of the charging case;

FIG. 20 is the same cross-sectional side view as FIG. 16, with the aerosol delivery system moved along a second ramp region of the recess;

FIG. 21 is a cross-sectional side view of an aerosol delivery system of a fourth embodiment;

FIG. 22 is a cross-sectional side view of a charging case of the fourth embodiment;

FIG. 23 is a close-up cross-sectional side view of a recess of the charging case of FIG. 22;

FIG. 24 is a cross-sectional side view of the charging case of FIG. 22, with the aerosol delivery system connected to the power connector;

FIG. 25 is a cross-sectional side view of the charging case of FIG. 22, with the aerosol delivery system in an intermediate position disconnected from the power connector;

FIG. 26 is a cross-sectional side view of the charging case of FIG. 22, with the aerosol delivery system in a second position wherein part of the system is rotated into the recess;

FIG. 27 is a cross-sectional side view of the charging case of FIG. 22, with the aerosol delivery system in a third position wherein a first end of the system abuts a ramp of the charging case;

FIG. 27A is a close-up cross-sectional side view of the ramp of the charging case of FIG. 22 and the first end of the aerosol delivery system, wherein the system is in the third position of FIG. 27; and,

FIG. 28 is a cross-sectional side view of the charging case of FIG. 22, with the aerosol delivery system in a fourth position wherein the system has been moved over a second ramp region of the recess.

### DETAILED DESCRIPTION

As used herein, the term “aerosol delivery device” is intended to encompass systems that deliver a substance to a user, and includes:
non-combustible aerosol provision systems that release compounds from an aerosolizable material without combusting the aerosolizable material, such as electronic cigarettes, tobacco heating products, and hybrid systems to generate aerosol using a combination of aerosolizable materials; and
articles comprising aerosolizable material and configured to be used in one of these non-combustible aerosol provision systems.

According to the present disclosure, a “combustible” aerosol provision system is one where a constituent aerosolizable material of the aerosol provision system (or component thereof) is combusted or burned in order to facilitate delivery to a user.

According to the present disclosure, a “non-combustible” aerosol provision system is one where a constituent aerosolizable material of the aerosol provision system (or component thereof) is not combusted or burned in order to facilitate delivery to a user. In embodiments described herein, the delivery system is a non-combustible aerosol provision system, such as a powered non-combustible aerosol provision system.

In one embodiment, the non-combustible aerosol provision system is an electronic cigarette, also known as a vaping device or electronic nicotine delivery system (END), although it is noted that the presence of nicotine in the aerosolizable material is not a requirement.

In one embodiment, the non-combustible aerosol provision system is a tobacco heating system, also known as a heat-not-burn system.

In one embodiment, the non-combustible aerosol provision system is a hybrid system to generate aerosol using a combination of aerosolizable materials, one or a plurality of which may be heated. Each of the aerosolizable materials may be, for example, in the form of a solid, liquid or gel and may or may not contain nicotine. In one embodiment, the hybrid system comprises a liquid or gel aerosolizable material and a solid aerosolizable material.

The solid aerosolizable material may comprise, for example, tobacco or a non-tobacco product.

Typically, the non-combustible aerosol provision system may comprise a non-combustible aerosol provision device and an article for use with the non-combustible aerosol provision system. However, it is envisaged that articles which themselves comprise a means for powering an aerosol generating component may themselves form the non-combustible aerosol provision system.

In one embodiment, the non-combustible aerosol provision device may comprise a power source and a controller. The power source may be an electric power source or an exothermic power source. In one embodiment, the exothermic power source comprises a carbon substrate which may be energized so as to distribute power in the form of heat to an aerosolizable material or heat transfer material in proximity to the exothermic power source. In one embodiment, the power source, such as an exothermic power source, is provided in the article so as to form the non-combustible aerosol provision.

In one embodiment, the article for use with the non-combustible aerosol provision device may comprise an aerosolizable material, an aerosol generating component, an aerosol generating area, a mouthpiece, and/or an area for receiving aerosolizable material.

In one embodiment, the aerosol generating component is a heater capable of interacting with the aerosolizable material so as to release one or more volatiles from the aerosolizable material to form an aerosol. In one embodiment, the aerosol generating component is capable of generating an aerosol from the aerosolizable material without heating. For example, the aerosol generating component may be capable of generating an aerosol from the aerosolizable material without applying heat thereto, for example via one or more of vibrational, mechanical, pressurization or electrostatic means.

In one embodiment, the aerosolizable material may comprise an active material, an aerosol forming material and optionally one or more functional materials. The active material may comprise nicotine (optionally contained in tobacco or a tobacco derivative) or one or more other non-olfactory physiologically active materials. A non-olfactory physiologically active material is a material which is included in the aerosolizable material in order to achieve a physiological response other than olfactory perception. The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical. In some embodiments, the active substance comprises nicotine. In some embodiments, the active substance comprises caffeine, melatonin or vitamin B12.

The aerosol forming material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more functional materials may comprise one or more of flavors, carriers, pH regulators, stabilizers, and/or antioxidants.

In one embodiment, the article for use with the non-combustible aerosol provision device may comprise aerosolizable material or an area for receiving aerosolizable material. In one embodiment, the article for use with the non-combustible aerosol provision device may comprise a mouthpiece. The area for receiving aerosolizable material may be a storage area for storing aerosolizable material. For example, the storage area may be a reservoir. In one embodiment, the area for receiving aerosolizable material may be separate from, or combined with, an aerosol generating area.

Aerosolizable material, which also may be referred to herein as aerosol generating material, is material that is capable of generating aerosol, for example when heated, irradiated or energized in any other way. Aerosolizable material may, for example, be in the form of a solid, liquid or gel which may or may not contain nicotine and/or flavorants. In some embodiments, the aerosolizable material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it.

The aerosolizable material may be present on a substrate. The substrate may, for example, be or comprise paper, card, paperboard, cardboard, reconstituted aerosolizable material, a plastics material, a ceramic material, a composite material, glass, a metal, or a metal alloy.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

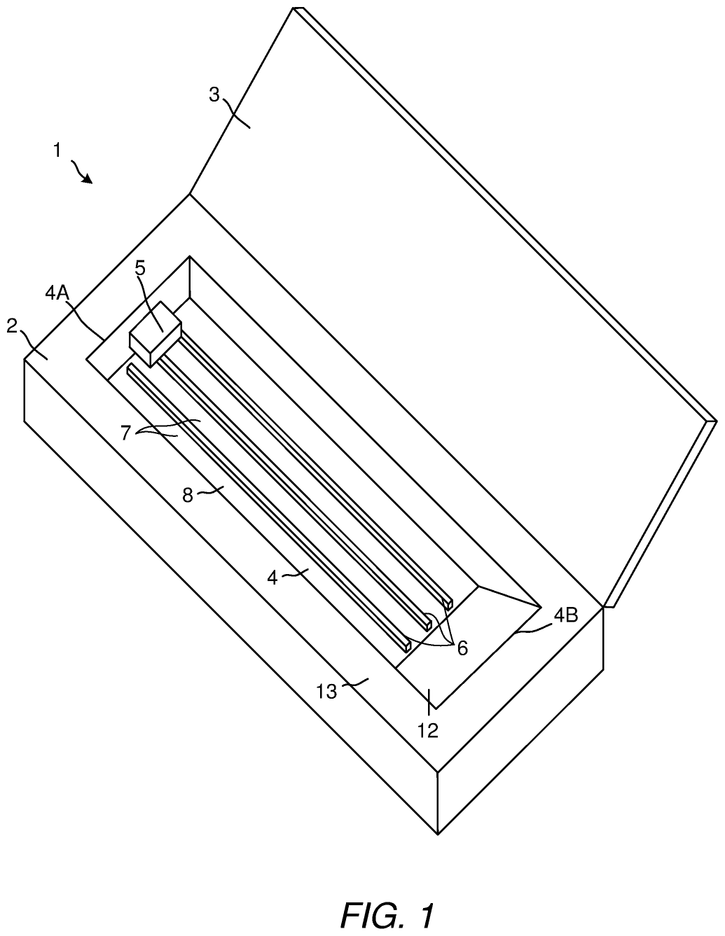

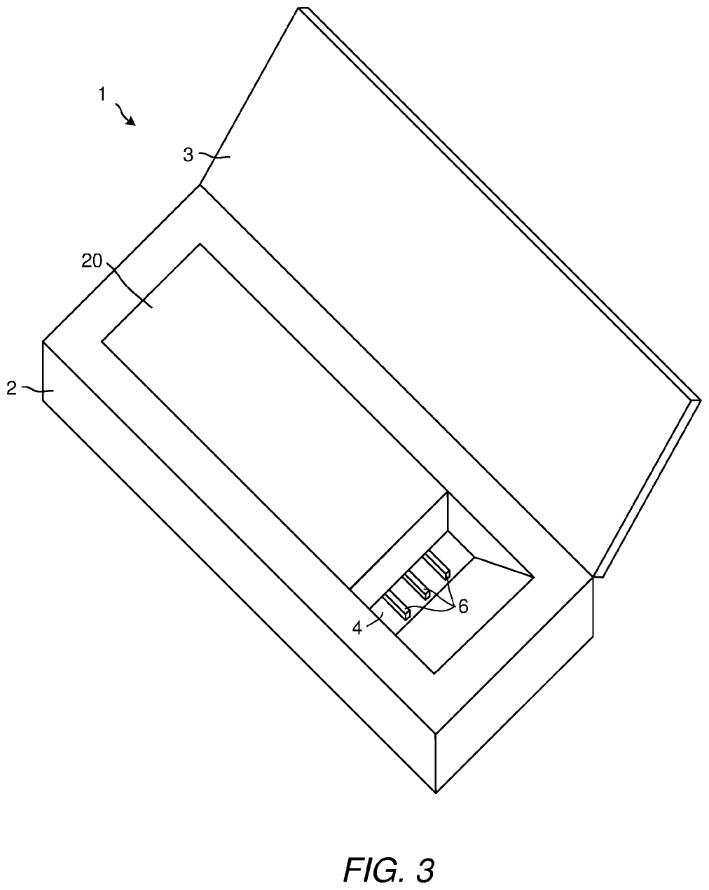

Referring now to FIGS. 1 to 12, a first embodiment of a charging case 1 for an aerosol delivery system 20 is shown.

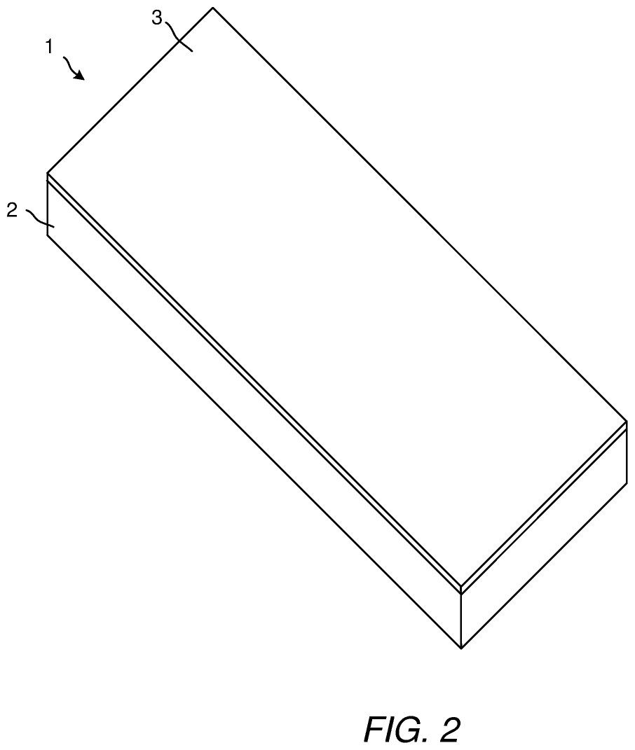

The charging case 1 comprises a main body 2 and a lid 3. In the present example, the lid 3 is hingedly attached to the main body 2 and is pivotable between an open position (shown in FIG. 1) and a closed position (shown in FIG. 2). However, it should be recognized that in other embodiments (not shown) the lid 3 may take a different form, for example, being slidable between open and closed positions, or screwed on and off of the main body 2. In further embodiments (not shown), the lid 3 is omitted.

The main body 2 includes a storage area 4 for storing an aerosol delivery system 20. In the present example, the storage area 4 comprises a cavity 4 in the main body 2 that receives the aerosol delivery system 20.

The charging case 1 includes a port 5 for interfacing with the aerosol delivery system 20. In the present example, the port 5 is a power connector 5 for charging a battery of an aerosol delivery system 20 stored in the storage area 4.

In the present example the aerosol delivery system 20 is an aerosol delivery device 20. The aerosol delivery system 20 may be a non-combustible aerosol generating system 20, although this is not essential. In the present example, the aerosol delivery device 20 is a non-combustible aerosol delivery device 20 and, preferably, is a tobacco heating system such as a tobacco heating device.

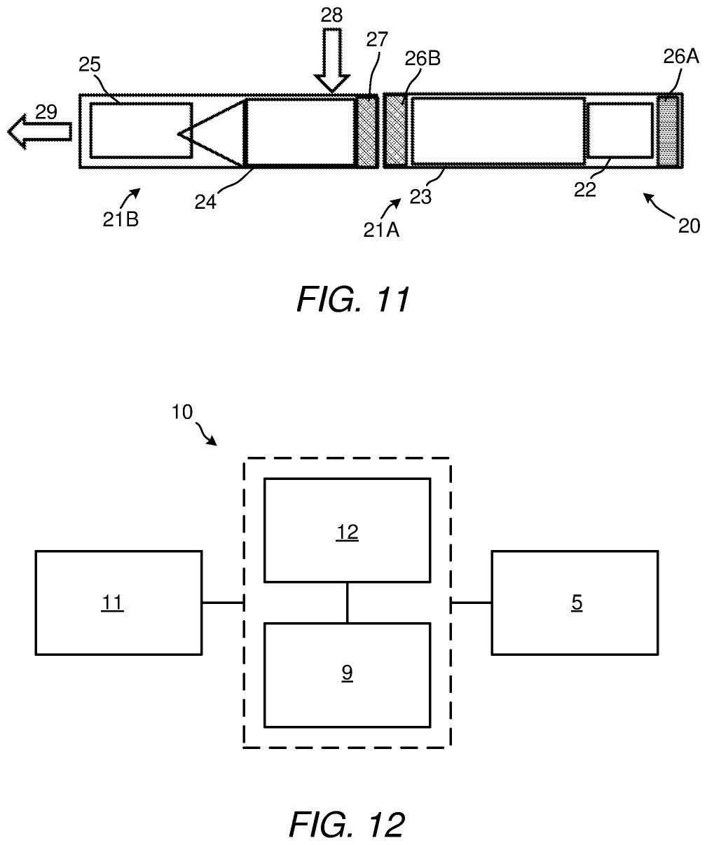

FIG. 11 is a block diagram of the non-combustible aerosol delivery device 20 in accordance with an example embodiment. The aerosol delivery device 20 may be stored within the storage area 4 of the charging case 1 described above. The device 20 is a modular device, comprising a first part 21A and a second part 21B. In some embodiments, the first part 21A and the second part 21B may be stored separately in the case 1 (e.g. detached from one another). In other embodiments (not shown), the first and second parts 21A, 21b are integrally formed, or only a first part is provided that houses the components of the device 20.

The first part 21a of the device 20 includes a control circuit 22 and a battery 23. The second part 21b of the device 20 includes a heater 24 and a liquid reservoir 25 (that may collectively form an aerosol generator).

The first part 21a includes a first connector 26a (such as a USB connector that connects to a port 5, for example, a USB port such as a USB-C connector, that connects to a USB-C port 5). The first connector 26A may enable connection to be made to a power source (e.g. a battery of the charging case 1 or an external power supply via the port 5 of the charging case 1) for charging the battery 23, for example under the control of the control circuit 22.

The first part 21A also includes a second connector 26B that can be removably connected to a first connector 27 of the second part 21B. In other embodiments (not shown), the first and second parts 21A, 21B may be permanently connected.

In the use of the device 20, air is drawn into an air inlet of the heater 24, as indicated by the arrow 28. The heater is used to heat the air (e.g. under the control of the circuit 23). The heated air is directed to the liquid reservoir 25, where an aerosol is generated. The aerosol exits the device at an air outlet, as indicated by the arrow 29 (for example into the mouth of a user of the device 20).

The liquid reservoir 25 may be provided by a removable article comprising an aerosol generating material. The aerosol generating material may comprise an aerosol generating substrate and an aerosol forming material.

It should be noted that the device 20 is described by way of example only. Many alternative systems (including combustible or non-combustible aerosol delivery systems) could be stored within the charging case 1 in accordance with example embodiments.

The main body 2 of the charging case 1 comprises one or more formations 6 that are configured to space at least a portion of the aerosol provision system 20 from the charging case 1 to provide an air gap 7 between the charging case 1 and the aerosol provision system 20.

In the present embodiment, each formation 6 is in the form of a protrusion 6 that projects out of a surface 8 of the main body 2. In the present example, each protrusion 6 is a rib 6. Each rib 6 is a longitudinal rib 6 that extends from proximate a first end 4a of the storage area 4 towards a second end 4B of the storage area 4. The ribs 6 may be parallel to each other.

In the present example, the charging case 1 comprises three formations 6, for example, three ribs 6. However, it should be recognized that in other embodiments the number of formations 6 can vary. In some embodiments (not shown), the charging case 1 comprises a single formation that is configured to space at least a portion of the aerosol provision system 20 from the charging case 1 to provide an air gap 7 (for example, on either side of the single formation). In other embodiments (not shown), the charging case 1 comprises at least two, three, four, five, six, seven, eight, nine or ten formations 6.

In some embodiments, the charging case 1 comprises at most twenty, fifteen, ten, nine, eight, seven, six, five, four, three or two formations 6.

In some embodiments, the charging case 1 comprises in the range of two to ten formations 6 and, preferably, in the range of three to five formations 6.

In some embodiments, the formations 6 are integrally formed with the charging case 1, for example, being integrally formed with the main body 2 or lid 3 of the charging case 1. In an alternative embodiment (not shown), one or more of the formations 6 may be a separate component that is attached to the main body 2 or lid 3 of the charging case 1, for example, by an adhesive.

In some embodiments, the part of the main body 2 comprising the formations 6 is molded, for example, being injection molded.

In some embodiments, the part of the main body 2 comprising the formations 6 is plastic. The formations 6 may be plastic and/or the storage area 4 of the main body 2 may be plastic.

In some embodiments, the total formations 6 are provided over less than 20% and, preferably, less than 15%, less than 10% or less than 5% of the total surface area of the surface 8 of the charging case 1 on which the formations 6 are provided.

In some embodiments, the total surface contact area of the or every formation 6 with the aerosol delivery system 20 when the aerosol delivery system 20 is located in the charging case 1 and is connected to the port 5 is at most 400 millimeters squared (mm²) and, preferably, at most 300, 250, 200, 150, 125 or 100 millimeters squared. The smaller the surface area of the formations 6 that is in contact with the aerosol delivery system 20, the smaller the friction between the aerosol delivery system 20 and the charging case 1 and thus the easier it is to remove the aerosol delivery system 20 from the storage area 4. A smaller surface area of the formations 6 also means that the size of the air gap 7 is increased.

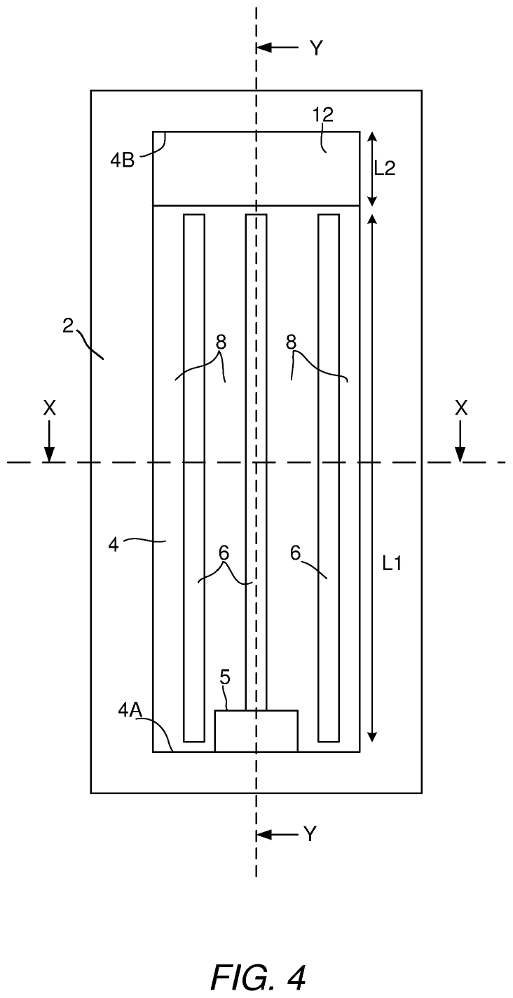

In some embodiments, the or each formation 6 has a length (shown by arrow ‘L1’ in FIG. 4) of at most 200 mm and, preferably, at most 180, 160, or 140, 130 or 120 mm.

In some embodiments, the or each formation 6 has a length L1 of at least 40 mm and, preferably, at least 60, 80, 100 or 120 mm.

The length L1 of each formation 6 is measured in the direction of the central axis A-A of the port 5. In the present example, each formation 6 extends parallel to the central axis A-A of the port 5. In the present example, each formation 6 extends parallel to the longitudinal axis of the charging case 1, between the first and second ends 4A, 4B of the storage area 4, and thus the length L1 of each formation 6 is also measured in a direction parallel to the longitudinal axis of the charging case 1.

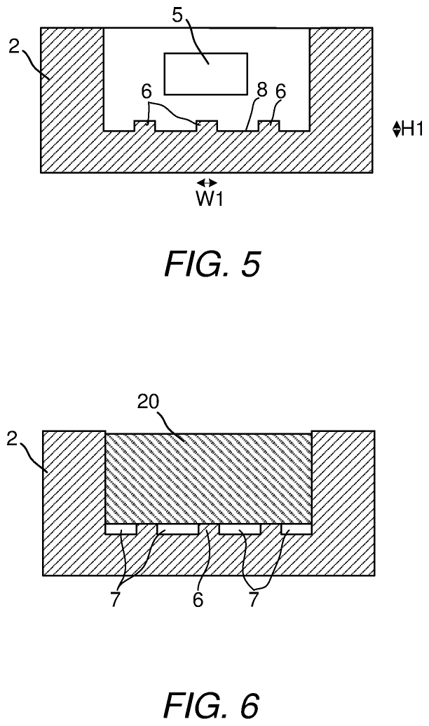

In some embodiments, the or each formation 6 has a width (shown by arrow ‘W1’ in FIG. 5) of at most 2 mm and, preferably, at most 1.5, 1, 0.9, 0.8, 0.7, 0.6 or 0.5 mm. Reducing the width W1 of the or each formation 6 reduces the friction between the formation(s) 6 and the aerosol delivery device 20.

In some embodiments, the or each formation 6 has a width W1 of at least 0.5 mm and, preferably, at least 0.6 mm.

In some embodiments, the or each formation 6 has a width W1 in the range of 0.5 to 2 mm and, preferably, in the range of 0.5 to 0.8 mm and, preferably, in the range of 0.6 to 0.7 mm.

The width W1 of each formation 6 is measured in a direction perpendicular to the direction of the central axis A-A of the port 5. In the present example, each formation 6 extends parallel to the central axis A-A of the port 5. In the present example, each formation 6 extends parallel to the longitudinal axis of the charging case 1, between the first and second ends 4A, 4B of the storage area 4, and thus the width W1 of each formation 6 is measured in a direction perpendicular to the longitudinal axis of the charging case 1.

In some embodiments, the or each formation 6 has a height (shown by arrow ‘H1’ in FIG. 5) of at most 1 mm and, preferably, at most 0.9, 0.8, 0.7, 0.6, 0.5, 0.4, 0.3 or 0.1 mm. It has been found that a smaller height H1 of the or each formation 6, the smaller the height of the charging case 1 and thus the charging case 1 is more portable.

In some embodiments, the or each formation 6 has a height H1 of at least 0.1 mm and, preferably, at least 0.2 mm. It has been found that increasing the height H1 of the formation(s) 6 makes the formation(s) more durable.

In some embodiments, the or each formation 6 has a height H1 in the range of 0.1 to 1 mm and, preferably, in the range of 0.1 to 0.5 mm and, preferably, in the range of 0.2 to 0.3 mm.

The height of each formation 6 is measured at the distance that the formation 6 protrudes from the surface 8 of the main body 2.

When the aerosol delivery system 20 is received in the storage area 4 and connected to the port 5, the battery 23 of the aerosol delivery system 20 is charged. That is, power is transferred from the battery 9 (or mains connector) of the charging case 1 to the battery 23 of the aerosol delivery system 20. This can cause the battery 23 of the aerosol delivery system 20 to increase in temperature. The air gap 7 provided by the formations 6 of the charging case 1 helps to cool the aerosol delivery system 20 within the charging case 1, as opposed to if the charging case 1 was tightly surrounded by the charging case 1 without any air gap 7. In addition, the air gap 7 helps to thermally insulate the charging case 1 from the charging aerosol delivery system 20 such that the exterior of the charging case 1 is cooler to touch. This is particularly advantageous when the user is holding the charging case 1 or has the charging case 1 on his or her person, for example, in a pocket. Such thermal insulation of the aerosol delivery system 20 from the charging case 1 is also advantageous if the aerosol delivery system 20 has been heated during use, for example, if the heater 24 has recently been operated and then the aerosol delivery system 20 is placed in the charging case 1. In such a circumstance, the air gap 7 helps the aerosol delivery system 20 to cool quicker than if no air gap 7 was provided.

In some embodiments, the storage area 4 is in the form of a cavity 4 in the main body 2. In the present example, the cavity 4 is a groove in the main body 2. The cavity 4 may extend longitudinally between the first and second ends 4A, 4B.

The port 5 may be a power connector 5. In some embodiments, the port 5 is a USB connector, for example, a USB-C connector.

In the present example, the port 5 is a male connector that connects with a female connector of the aerosol delivery system 20. In other embodiments (not shown), the port 5 is a female connector that connects with a male connector of the aerosol delivery system 20.

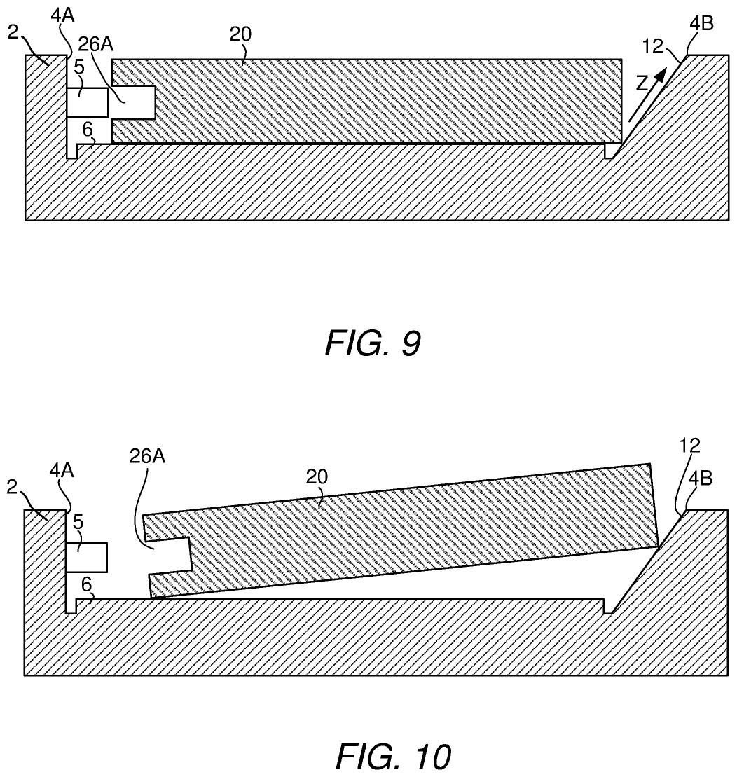

In some embodiments, the port 5 is configured such that, in use, the aerosol delivery system 20 is slid towards from the port 5 to connect to the port 5, from the position shown in FIG. 9 to the position shown in FIG. 8.

In some embodiments, the port 5 is configured such that, in use, the aerosol delivery system 20 is slid away from the port 5 to disconnect from the port 5, from the position shown in FIG. 8 to the position shown in FIG. 9.

The formations 6 reduce the contact area between the aerosol delivery system 20 and the charging case 1 and therefore reduce the friction between the aerosol delivery system 20 and the charging case 1. This makes it easier to connect and disconnect the aerosol delivery system 20 from the port 5.

To disconnect the aerosol delivery system 20 from the port 5, the user can place a thumb and/or one or more fingers on the aerosol delivery system 20 and slide the aerosol delivery system 20 away from the port 5. It has been found that sometimes the user will have a tendency to push his or her thumb or finger into the aerosol delivery system 20 when initially attempting to slide the aerosol delivery system 20 in order to increase the grip on the aerosol delivery system 20 such the friction between the port 5 and the aerosol delivery system 20 is overcome. That is, the user will push the aerosol delivery system 20 downwardly (in the direction of arrow ‘F’ in FIG. 8) towards the surface 8 when trying to disconnect the aerosol delivery system 20 from the port 5, and this pushing motion will increase the friction between the user's thumb or finger and the aerosol delivery system 20 and thereby improve the user's grip. However, it has been found that this downward pushing motion can exert a force on the port 5 that can damage the port 5 and/or aerosol delivery system 20.

To help avoid such damage, in some embodiments at least one formation 6 is arranged such that the formation 6 is in contact with the aerosol delivery system 20 when the aerosol delivery system 20 is connected to the port 5. The formation 6 therefore provides a reaction surface in the event that the aerosol delivery system 20 is pushed downwardly towards the surface 8, and therefore the formations 6 support the aerosol delivery system 20 to prevent damage to the aerosol delivery system 20. In some embodiments, a plurality of formations 6 are arranged such that said formations 6 are in contact with the aerosol delivery system 20 when the system 20 is connected to the port 5.

In some embodiments, at least one of the formations 6 is provided proximate to the port 5 to support the aerosol delivery system 20 in proximity to the port 5. In some embodiments, at least one of the formations 6 extends underneath the port 5.

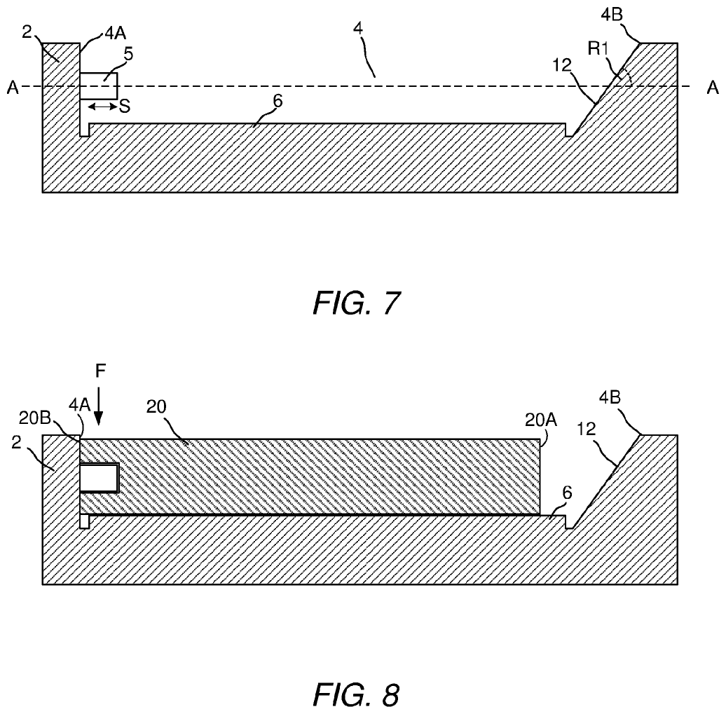

In some embodiments, at least one of the formations 6 at least partially co-extends with at least a portion of the port 5 in the axial direction (shown by arrow ‘A-A’ in FIG. 7) of the port 5. The area of co-extension (i.e. overlap of the formation 6 with the port 5 in the axial direction A-A of the port 5) is shown by arrow ‘S’ in FIG. 7. This helps to ensure that a portion of the aerosol delivery system 20 in contact with the port 5 is supported by the at least one of the formations 6 to prevent damage to the port 5.

In some embodiments, at least one of the formations 6 overlaps with the port 5 in the axial direction A-A of the port 5.

In some embodiments, the port 5 is provided at or in proximity to the first end 4A of the storage area 4, and wherein the aerosol delivery system 20 is slid towards the second end 4B of the storage area 4 to disconnect the aerosol delivery system 20 from the port 5 such that the aerosol delivery system 20 can be removed from the storage area 4.

In some embodiments, the main body 2 comprises a ramp 12 at the second end 4B of the storage area 4. The storage area 4 may comprise a cavity 4.

The ramp 12 is configured such that when the aerosol delivery system 20 is slid away from the port 5, a first end 20A of the aerosol delivery system 20 abuts the ramp 12 and is slid along the ramp 12 (in the direction of arrow ‘Z’ in FIG. 9) such that the aerosol delivery system 20 is lifted out of the storage area 4. This makes it easier to remove the aerosol delivery system 20 from the charging case 1. For example, the user can grip the front end 20A of the aerosol delivery system 20 as it moves along the ramp 12 and is lifted out of the storage area 4 (as shown in FIG. 10). This makes it easier to remove the aerosol delivery system 20 from the charging case 1.

In some embodiments, the aerosol delivery system 20 comprises a first end 20A distal to the first connector 26A (and thus distal to the port 5 when the aerosol delivery system 20 is connected to the port 5) and a second end 20B that is proximate to the first connector 26A. The first end 20A of the aerosol delivery system 20 is slid along the ramp 12 after disconnection of the aerosol delivery system 20 from the port 5 such that the first end 20A is lifted out of the storage area 4. The user can therefore grip the first end 20A with his or her fingers to remove the aerosol delivery device 20 from the storage area 4.

In some embodiments, the charging case 1 comprises a first surface 13 and the storage area 4 extends into the first surface 13. Optionally, the ramp 12 extends to the first surface 13. The first surface 13 may be generally planar.

In some embodiments, the first surface 13 is a top surface 13. For example, the first surface 13 may be a top surface 13 of the main body 2 and may be covered by the lid 3 when the lid 3 is closed.

In the embodiment of FIGS. 1 to 12, at least a portion of the ramp 12 follows a substantially linear path. In fact, in the present embodiment the ramp 12 is a generally planar surface and the entire ramp 12 follows a substantially linear path. However, it should be recognized that in other embodiments at least some or all of the ramp 12 may follow a non-linear path, for example, at least some or all of the ramp 12 may follow a substantially curved path.

The main body 2 or lid 3 may comprise the ramp 12. In some embodiments, the ramp 12 is integrally formed with the main body 2 or lid 3. In other embodiments, the ramp 12 is a separate component that is attached to the main body 2 or lid 3, for example, by adhesive.

In some embodiments, the ramp 12 has a length (shown by arrow ‘L2’ in FIG. 4), of at least 0.6 mm and, preferably, at least 0.7 mm, 0.8 mm, 0.9 mm or 1 mm. The length of the ramp 12 is measured from a first end of the ramp 12 proximate to the port 5 to a second end of the ramp 12 distal to the port 5.

In the present example, the part of the aerosol delivery system 20 that moves along the ramp 12 when the component of the aerosol delivery system 20 is moved away from the port 5 is the first part 21A of the aerosol delivery system 20. However, in other embodiments the part of the aerosol delivery system 20 that moves along the ramp 12 when the component of the aerosol delivery system 20 is moved away from the port 5 is the second part 21B of the aerosol delivery system 20.

In one embodiment, the first and second parts 21A, 21B are stored separately in the charging case 1, for example, in different storage areas. The first part 21A may be disconnected from the port 5 and moved away therefrom such that the first part 21A moves up the ramp 21 for removal by the user. The first part 21A may then be connected to the second part 21B, which may be supplied separately or provided in a different portion of the charging case 1.

In the present example, the ribs 6 extend to, but terminate at or short of, the ramp 12. However, in other embodiments (not shown) the ribs 6 are sloped such that they form at least a part of the ramp 12. For example, in one embodiment (not shown) the ribs 6 extend from the first end 4A of the storage area 4 in a direction parallel to the central axis A-A of the port 5, and then slope up to the second end 4B of the storage area 4 to form the ramp 12.

In some embodiments, the aerosol provision system 20 comprises an aerosol delivery device 20 and, optionally, the entire aerosol delivery device 20 may be moved together in the direction away from the port 5.

In some embodiments, at least a portion of the ramp 12 extends at an angle (shown by ‘R1’ in FIG. 7) of at least 45 degrees relative to a central axis A-A of the port 5 in a direction away from the port 5, and preferably, at an angle R1 of at least 50, 60, 70, 75, 80, 85, 86 or 87 degrees. The steeper the angle R1, the greater the distance that the aerosol delivery system 20 will be lifted out of the storage area 4 for a given movement of the system 20 away from the port 5.

In some embodiments, at least a portion of the ramp 12 extends at an angle R1 of at most 89 degrees relative to a central axis A-A of the port 5 in a direction away from the port 5, and preferably, at an angle R1 of at most 88 or 87 degrees. A shallower angle R1 of the ramp 12 makes it easier to push the aerosol delivery system 20 against the ramp 12.

In some embodiments, the ramp 12 is arranged such that the aerosol delivery system 20 only moves along the ramp 12 once the system 20 has been disconnected from the port 5 and, preferably, only when the system 20 is spaced from the port 5. This helps to prevent damage to the port 5 and/or system 20 due to the system 20 being lifted out of alignment with the central axis A-A of the port 5 whilst still connected thereto.

In some embodiments (not shown), the ramp 12 comprises first and second ramp portions. The first and second ramp portions may extend substantially parallel to each other. In some embodiments, each of the first and second ramp portions may be arranged to contact a corresponding part of the aerosol delivery system 20, for example, a corresponding corner of the aerosol delivery system 20 when the system 20 is moved away from the port 5. Each ramp portion may comprises a respective ramped surface. The first and second ramp portions may be provided on opposite sides of the central axis A-A of the port 5.

In some embodiments, at least one of the formations 6 is provided in proximity to the ramp 12 such that the aerosol delivery system 20 moves from the at least one formation 6 and on to the ramp 12. Thus, the or each formation 6 guides the aerosol delivery system 20 away from the port 5 and on to the ramp 12 for removal from the storage area 4. For example, at least one formation 6 may be provided within 5 cm and, preferably, less than 4 cm, 3 cm, 2 cm, or 1 cm of the ramp 12. In some embodiments (not shown), at least one of the formations 6 may partially or entirely form the ramp 12.

In some embodiments, the or each formation 6 is arranged such that at least one formation 6 is in contact with the aerosol delivery system 20 at all times from when the system 20 is disconnected from the port 5 until the system 20 contacts the ramp 12.

In the present example, the or each formation 6 extends continuously from a location at or proximate to the first end 4A of the storage area 4 to a location at or proximate to the second end 4B of the storage area 4B. However, it should be recognized that in other embodiments, the or each formation 6 may extend intermittently between the first and second ends 4A, 4B of the storage area 4.

In the present example, the main body 2 comprises one or more formations 6 that are configured to space at least a portion of the aerosol provision system 20 from the main body 2 to prove an air gap between the aerosol provision system 20 and the main body 2. In other embodiments (not shown), the lid 3 additionally comprises one or more formations that are configured to space at least a portion of the aerosol provision system 20 from the lid 3 to prove an air gap between the aerosol provision system 20 and the main body 3. The formations of the lid will also help to reduce the temperature of the aerosol delivery system 20 and will thermally insulate the lid 3 from the aerosol delivery system 20 to reduce the temperature of the lid 3. In some embodiments, the lid 3 comprises said formations and the main body 2 does not comprise the formations. However, an advantage of the main body 2 comprising formations is that the formations reduce friction with, and/or provide support to, the aerosol delivery system 20 during connection/disconnection with the port 5.

In the present example, the or each formation 6 extends continuously from a location at or proximate to the first end 4A of the storage area 4 to a location at or proximate to the ramp 12 of the storage area 4B. However, it should be recognized that in other embodiments, the or each formation 6 may extend intermittently between the first end 4A, 4B of the storage area 4 and the ramp 12. In yet further embodiments (not shown), the or each formation 6 may extend continuously/intermittently between the first and second ends 4A, 4B of the storage area 4.

In the present example, the main body 2 comprises one or more formations 6 that are configured to space at least a portion of the aerosol provision system 20 from the main body 2 to provide an air gap between the aerosol provision system 20 and the main body 2. In other embodiments (not shown), the lid 3 additionally or alternatively comprises one or more formations that are configured to space at least a portion of the aerosol provision system 20 from the lid 3 to prove an air gap between the aerosol provision system 20 and the lid 3. The formations of the lid 3 will also help to reduce the temperature of the aerosol delivery system 20 and will also thermally insulate the lid 3 from the aerosol delivery system 20 to reduce the temperature of the lid 3. In some embodiments, the lid 3 comprises said formations and the main body 2 does not comprise the formations. However, an advantage of the main body 2 comprising formations is that the formations reduce friction with, and/or provide support to, the aerosol delivery system 20 during connection/disconnection with the port 5.

In the present example, the main body 2 comprises the storage area 4. In other embodiments (not shown), alternatively, or additionally, the lid 3 may comprise a storage area for the aerosol delivery system 20. For example, a cavity (not shown) may be provided in the lid 3 to receive at least part of the aerosol delivery system 20.

FIG. 12 is a block diagram showing a charging system 10 of the charging case 1. The charging system 10 comprises a power connector 11 that is configured to connect to an external power supply (e.g. a mains electricity supply, external battery or vehicle charging point) in order to charge the battery 9 of the charging case 1 (or to charge the battery 23 of the aerosol delivery system 20 directly, for example, if the battery 23 of the system 20 is depleted and/or if the battery 9 of the charging case 1 is omitted). The charging system 10 further comprises the battery 9 of the charging case 1 and the port 5 for connection to the first connector 26A of the aerosol delivery system 20. The charging system 10 may further comprise a controller 12 for controlling the flow of power to and/or from the battery 9.

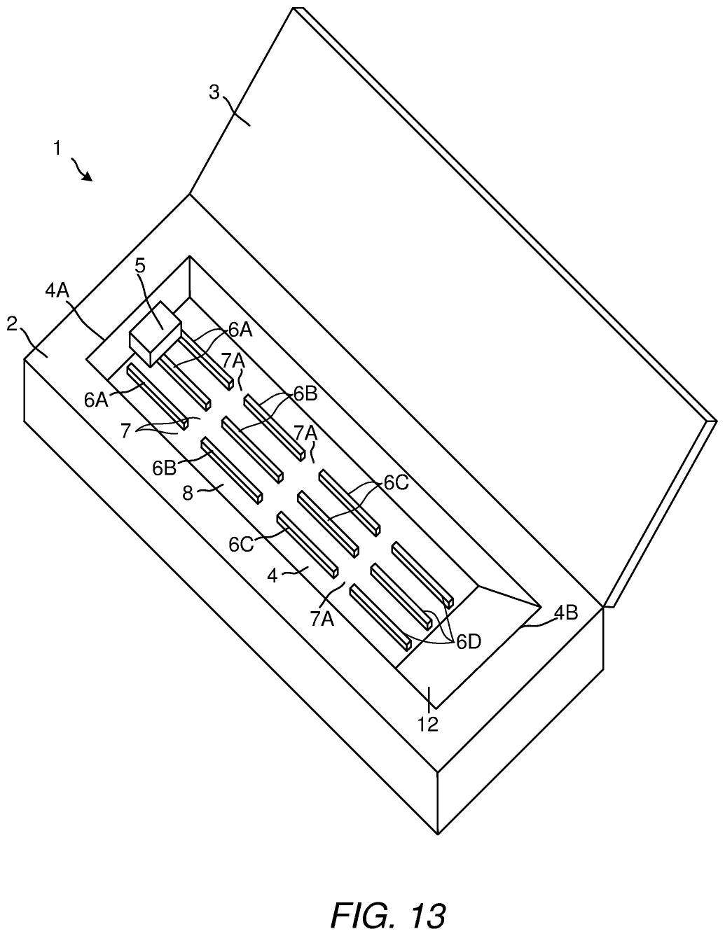

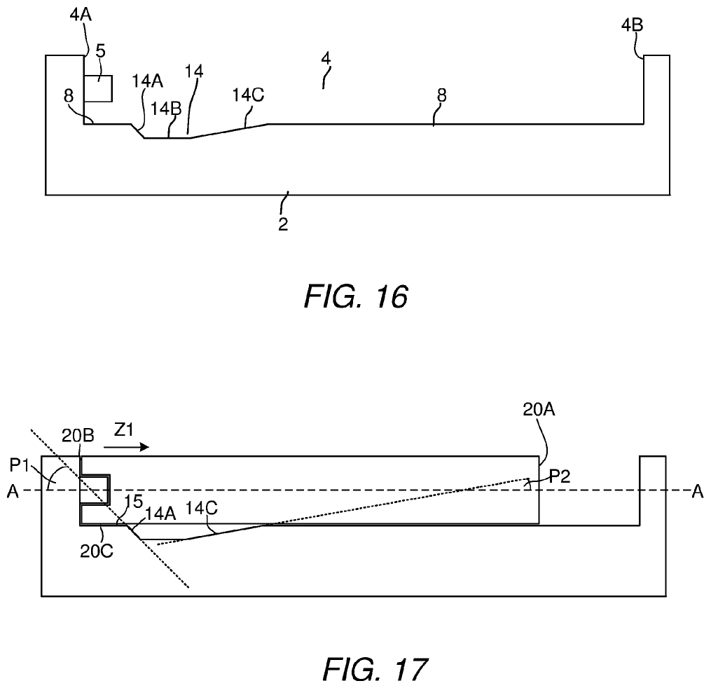

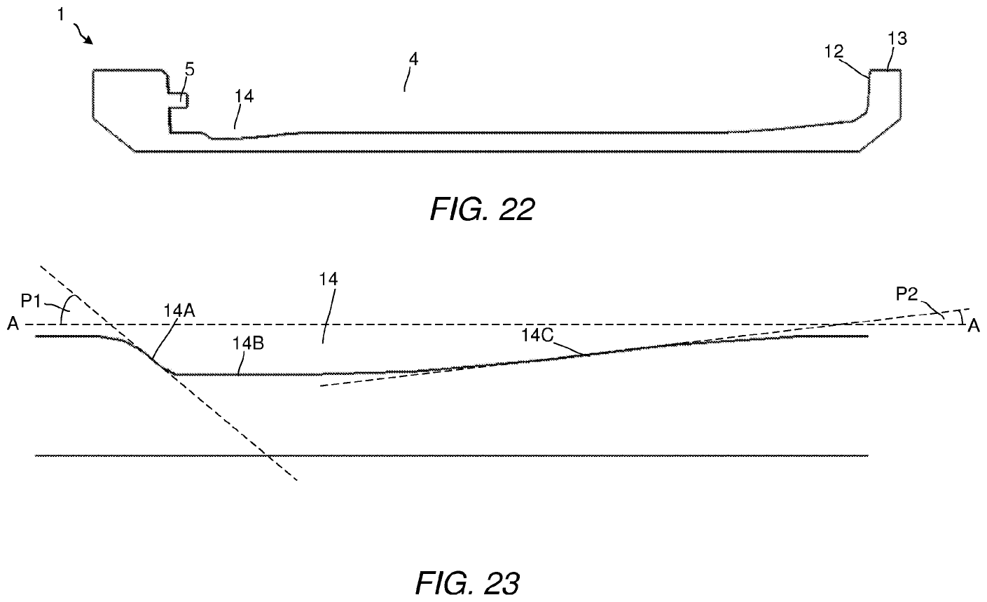

In one alternative embodiment (not shown) the charging case 1 comprises a curved storage area configured to accommodate an aerosol delivery system (not shown) having a curved profile. Therefore, the surface from which the formations 6 project is generally curved. In one such embodiment (not shown), each formation 6 is a protrusion 6, for example, a rib 6, with a generally convex cross-section. The cross-sectional shape of each protrusion 6 may be generally curved. This reduces the contact area between the protrusions 6 and the aerosol delivery system 20, which reduces heat transfer between the aerosol delivery system 20 and charging case 1 and also reduces friction between the aerosol delivery system 20 and charging case 1 such that less force is required to connect and disconnect the aerosol delivery system 20 with the port 5. It should be recognized that the first embodiment of FIGS. 1 to 12 and the second, third and fourth embodiments of FIGS. 13 to 27 described below could be modified to have a curved surface 8 and/or convex and/or curved formations 6. In some embodiments, the storage area 4 has a U-shaped cross-section.

Referring now to FIG. 13, a second embodiment of a charging case 1 is shown. The charging case 1 of the second embodiment is similar to the charging case 1 of the first embodiment of FIGS. 1 to 12 and has similar features. A difference is that each continuous formation 6 of the first embodiment is omitted and is replaced by a plurality of spaced formations 6A, 6B, 6C, 6D.

That is, the charging case 1 of the second embodiment comprises a first row of formations 6A, a second row of formations 6B, a third row of formations 6C and a fourth row of formations 6D. A space 7A is provided between the formations 6A, 6B, 6C, 6D of adjacent rows, wherein the space 7A forms part of the air gap 7 between the charging case 1 and the aerosol delivery system 20.

A disadvantage of the second embodiment of FIG. 13 in comparison to the first embodiment of FIGS. 1 to 12 is that the formations 6A, 6B, 6C, 6D extend discontinuously from the first end 4A of the storage area 4 to the ramp 12 and thus, in certain configurations, the aerosol delivery system 20 may be more prone to catching or snagging on the edges or corners of the spaced formations 6A, 6B, 6C, 6D.

On the other hand, the space 7A between adjacent formations 6A, 6B, 6C, 6D increases the size of the air gap 7 between the charging case 1 and the aerosol delivery device 20, thus promoting cooling of the aerosol delivery device 20 and reducing heat transfer between the charging case 1 and the aerosol delivery device 20.

In the present example, the formations 6A, 6B, 6C, 6D are aligned to form a plurality of columns of formations 6A, 6B, 6C, 6D. In the present example, the charging case 1 comprises three columns of formations 6A, 6B, 6C, 6D, with four formations 6A, 6B, 6C, 6D in each column. In the present example, the charging case comprises four rows of formations 6A, 6B, 6C, 6D, with three formations 6A, 6B, 6C, 6D provided in each row. However, it should be recognized that in other embodiments the charging case 1 may comprise a different number of formations in each row and/or column. The charging case 1 may also comprise a different number of rows and/or columns of formations.

In the present example, the formations 6A, 6B, 6C, 6D are provided in regular rows and columns. This allows for a more uniform thermal air gap 7 between the charging case 1 and the aerosol delivery system 20. However, in other embodiments (not shown), the formations may be provided in irregular rows and/or irregular columns.

In the present example, all of the formations 6A, 6B, 6C, 6D are the same shape. However, in other embodiments, some of the formations 6A, 6B, 6C, 6D may have a different shape.

In each of the above embodiments, the formations 6, 6A, 6B, 6C, 6D are longitudinal ribs 6, 6A, 6B, 6C, 6D. However, it should be recognized that the formations may have any other shape. For example, the formations may be circular. The formations may be spaced apart such that spaces 7A are formed between adjacent formations. The formations may be protrusions 6, 6A, 6B, 6C, 6D that project from a surface 8 of the main body 2 and/or lid 3. The top of the formations may be generally flat or the formations may each have a generally convex cross-section and the cross-sectional shape of the or each formation may be generally curved, which reduces the contact area between the aerosol delivery system 20 and the charging case 1. The or each formation may be dome shaped.

It should be recognized that in variations of the embodiments described above the formations 6 may be a different shape, for example, oval, square, triangular, polygonal, pentagonal or hexagonal.

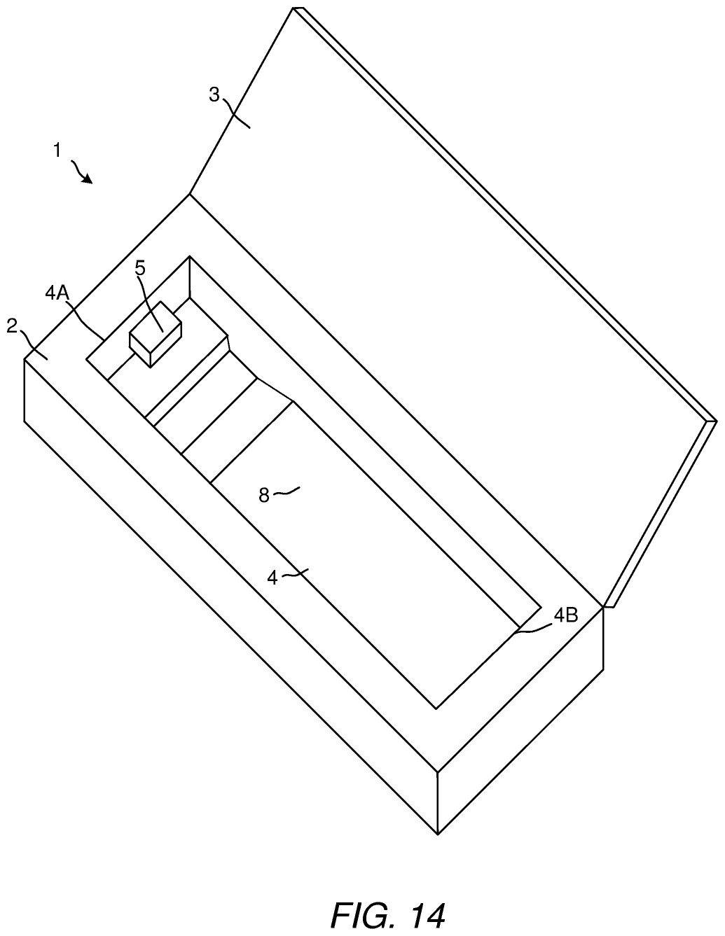

Referring now to FIGS. 14 to 20, a charging case 1 according to a third embodiment is shown. The charging case 1 of the third embodiment is similar to the charging case 1 of the first embodiment of FIGS. 1 to 12 and has similar features. A difference is that the ramp 12 is omitted and instead the charging case 1 of the third embodiment comprises a recess 14. In other embodiments, the charging case 1 may comprise both a ramp 12 and a recess 14.

The recess 14 is located in the storage area 4 of the main body 2. In the present example, the storage area 4 comprises a cavity 4 that extends in the direction of the central axis A-A of the port 5, and wherein the recess 14 is provided in a bottom surface 8 of the storage area 4. The recess 14 underlies the aerosol delivery system 20 when the aerosol delivery system 20 is connected to the port 5.

In an alternative embodiment (not shown), the recess 14 is provided in the lid 3, for example, in a storage area in the lid 3.

The recess 14 is arranged such that when a component of the aerosol delivery device 20 has been disconnected from the port 5 a portion of the component can enter the recess 14 to allow the component to rotate relative to the charging case 1. In the present example, said component is the first part 21A of the aerosol delivery system 20. However, it should be recognized that in other embodiments, said component may be a different part of the aerosol provision system 20, for example, the second part 21B.

In some embodiments, the component comprises the battery 23 of the aerosol delivery system 20.

In the present example, the aerosol delivery system 20 is an aerosol delivery device 20, and wherein the entire aerosol delivery device 20 is moved away from the port 5 to disconnect the component from the port 5. Therefore, in the following example, the aerosol delivery system 20 is described as being disconnected from the port 5, rotated relative to the charging case 1 and then removed from the charging case 1. Therefore, disconnection and rotation of the component may refer to disconnection and rotation of the entire aerosol deliver system 20. However, in other embodiments (not shown), said component is stored in the charging case 1 separately to other components of the aerosol delivery system 20. For example, the first part 21A may be disconnected from the port 5, rotated relative to the charging case 1 and removed from the storage area 4 and then connected to a second part 21B of the aerosol delivery system 20 that is provided separately.

The recess 14 allows the aerosol delivery system 20 to rotate relative to the charging case 1 such that the aerosol delivery system 20 is easier to remove from the charging case 1.

The aerosol delivery system 20 is initially in a first position (shown in FIG. 17), wherein the aerosol delivery system 20 is connected to the port 5 for charging. To remove the aerosol delivery system 20 from the charging case 1, the user first urges the aerosol delivery system 20 in a first direction (shown by arrow ‘Z1’ in FIG. 17) away from the port 5. In the present example, the aerosol delivery system 20 is slid in the first direction Z1 away from the port 5.

The aerosol delivery system 20 has first and second ends 20A, 20B. The first end 20A is distal to the port 5 when the aerosol delivery system 20 is connected to the port 5. The second end 20B comprises the first connector 26A that connects to the port 5. The first and second ends 20A, 20B are at opposite ends of the aerosol delivery system 20.

In the first position, the aerosol delivery system 20 is prevented from rotating into the recess 14. This is because a portion 20C of the aerosol delivery system 20 towards the second end 20B of the aerosol delivery system 20 abuts a region 15 of the charging case 1 that is outside of the recess 1. The recess 14 is located between the first and second ends 20A, 20B of the aerosol delivery system 20 in the axial direction A-A of the port 5. Said region 15 of the charging case is located on the side of the recess 14 that is proximate to the port 5.

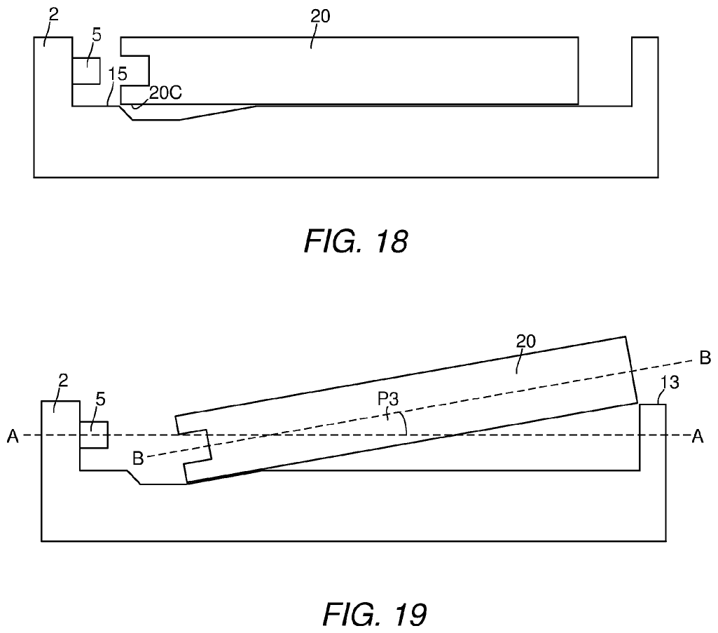

The aerosol delivery system 20 is moved relative to the charging case 1 in the first direction Z1 until said portion 20C of the aerosol delivery system 20 no longer contacts said region 15 of the charging case 1 and instead overlies the recess 14, at which point the aerosol delivery system 20 is in an intermediate position (shown in FIG. 18). The aerosol delivery system 20 is therefore no longer prevented from rotating into the recess 14.

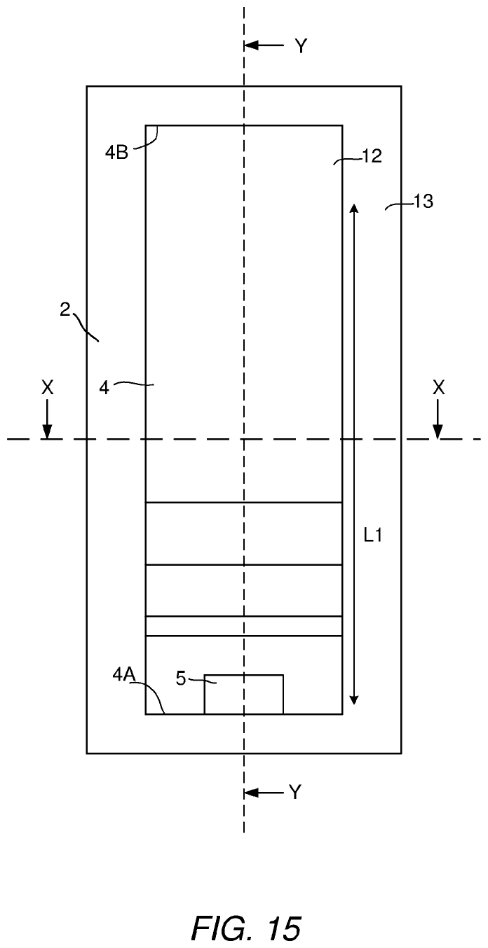

With the aerosol delivery system 20 in the intermediate position, the user can then push down on the second end 20B of the aerosol delivery system 20 in order to urge said portion 20C of the aerosol delivery system 20 into the recess 14 such that the system 20 moves to a second position. Thus, the aerosol delivery system 20 rotates relative to the charging case 1 about a rotational axis that is perpendicular to the central axis A-A of the port 5. The rotational axis of the aerosol delivery system 20 is parallel to line X-X shown in FIG. 15.

In the above described embodiment, the aerosol delivery system 20 is first moved to the intermediate position, and the user then pushes down on the second end 20B of the aerosol delivery system 20 in order to urge said portion 20C of the aerosol delivery system 20 into the recess 14. However, it should be recognized that this may be one fluid motion. For example, the user may already be pushing downwardly on the aerosol delivery system 20 to disconnect the system 20 from the port 5, because this will increase friction between the user's finger and the system 20 and thus the user's grip on the system 20 (i.e. in the direction of arrow ‘F’ shown in FIG. 8 as discussed above in reference to the first embodiment). Thus, once the system 20 has slid away from port 5 to a position wherein said portion 20 of the system 20 overlies the recess 14, said portion 20C will immediately enter the recess 14.

The recess 14 is spaced from the port 5 in the first direction Z1 and therefore the aerosol delivery system 20 can only enter the recess 14 after disconnection from the port 5. This prevents damage to the port 5 and/or aerosol delivery system 20 that could otherwise be caused by the aerosol delivery system 20 being urged to rotate relative to the port 5 prior to disconnection therefrom.

In the present example, the recess 14 comprises a first ramp region 14A configured such that the portion 20C of the aerosol delivery system 20 can move along the first ramp region 14A in a direction away from the port 5 to move into the recess 14. The first ramp region 14A may therefore help to guide the aerosol delivery system 20 into the recess 14.

In some embodiments, at least a portion of the first ramp region 14A extends at an angle P1 of at least 5 degrees relative to the central axis A-A of the port 5 in a direction away from the port 5 and, preferably, at least 10, 12, 14, 16 or 18 degrees. The steeper the angle P1 of the first ramp region 14A, the larger the rotation of the aerosol delivery system 20 relative to the charging case 1 when the aerosol delivery system 20 slides down the first ramp region 14A.

In some embodiments, the first ramp region 14A extends at a first angle P1 of at most 45 degrees relative to the central axis A-A of the port 5 in a direction away from the port 5 and, preferably, at most 30, 25, 20 or 18 degrees.

In some embodiments, the first ramp region 14A is generally planar. The first ramp region 14A may comprise a generally planar surface.

In some embodiments, at least a portion of the first ramp region 14A follows a non-linear path and, preferably, is curved.

The aerosol delivery system 20 is rotated into the recess 14 and moves along the first ramp region 14A until said portion 20C of the aerosol delivery system 20 abuts an intermediate region 14B at the bottom of the recess 14. The aerosol delivery system 20 may then be moved in the first direction Z1 by the user such that the aerosol delivery system 20 moves along the intermediate region 14B until said portion 20C of the aerosol delivery system 20 (or another part of the system 20) comes contact with a second ramp region 14C that is located at the opposite side of the intermediate regions 14B to the first ramp region 14A, wherein the aerosol delivery system 20 is in a third position (shown in FIG. 19).

The intermediate region 14B thus extends between the first and second ramp regions 14A, 14C. In some embodiments, the intermediate region 14B follows a generally linear path and, preferably, the generally linear path is substantially parallel to the central axis A-A of the port 5. In an alternative embodiment (not shown), the intermediate region 14B is omitted and instead the first ramp region 14A extends to the second ramp region 14C. In yet further embodiments (not shown), one or both of the first and second ramp regions 14A, 14C may be omitted. In one embodiment, the first and second ramp regions 14A, 14C are omitted and instead a stepped recess is provided. The recess may have a generally square profile.

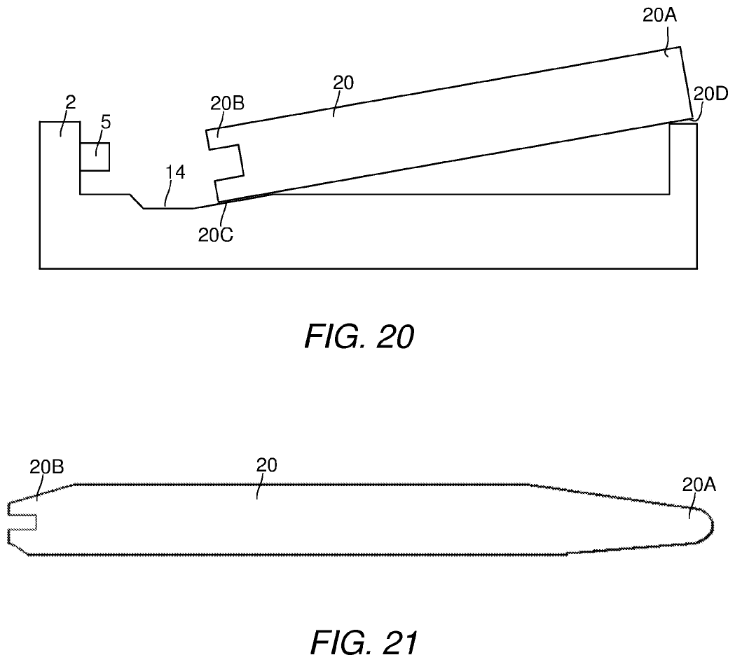

In some embodiments, the second ramp region 14C is configured such that the aerosol delivery system 20 can move along the second ramp region 14C in a direction away from the port 5 such that the aerosol delivery system 20 moves to a fourth position (shown in FIG. 20) wherein a part 20D of the aerosol delivery system 20 at the first end 20A of the aerosol delivery system 20 moves out of the charging case 1. In the present example, said portion 20C of the aerosol delivery system 20 moves along the second ramp region 14C between the third and fourth positions. However, in other embodiments a different portion of the aerosol delivery system 20 may move along the second ramp region 14C.

The user may grip the first end 20A of the aerosol delivery system 20 when the aerosol delivery system 20 is moved to the fourth position and then remove the aerosol delivery system 20 from the storage area 4. Thus, the recess 14 facilitates easier removal of the aerosol delivery system 20.

In some embodiments, the second ramp region 14C is generally planar and may comprises a generally flat surface.

In some embodiments, the first ramp region 14A, intermediate portion 14B and/or second ramp region 4C may be formed by one or more formations (not shown) instead of a planar surface(s). For example, in one embodiment (not shown) the charging case 1 comprises longitudinal ribs 6 (or a plurality of discrete protrusions) that extend between the first and second ends 4A, 4B of the storage area 4. The ribs 6 may extend parallel to the central axis A-A of the port 5 in the vicinity of the port 5, then slope away from the central axis A-A in the first direction Z1 to form the first ramp region 14A of the recess 14, then extend parallel to the central axis A-A to form the intermediate portion 14B, then slope towards the central axis A-A in the first direction Z1 to form the second ramp region 14C, and then extend parallel to the central axis A-A to the second end 4B of the storage area 4.

In some embodiments, at least a portion of the second ramp region 14C extends at a second angle P2 of at least 1 degrees relative to the central axis A-A of the port 5 in a direction towards the port 5 and, preferably, at least 1.5, 2 or 2.5 degrees. The larger the second angle P2 that the second ramp region 14C extends relative to the central axis A-A, the larger the angle that the aerosol delivery system 20 will be relative to the central axis A-A of the port 5 when in the third and fourth positions and thus the greater the extent that the first end 20A of the system 20 will be lifted out of the storage area 4.

In some embodiments, the first angle P1 that the first ramp region 14A extends relative to the central axis A-A is different to the second angle P2 that the second ramp region 14C extends relative to the central axis A-A and, preferably, is larger than the second angle P2.

In some embodiments, the second ramp region 14C extends at an angle P2 of at most 10 degrees relative to the central axis A-A of the port 5 in a direction towards the port 5 and, preferably, at most 8, 6, 4, 3 or 2.5 degrees.

In some embodiments, at least a portion of the second ramp region 14C follows a substantially linear path.

As shown in FIGS. 19 and 20, the second ramp region 14C is configured such that the aerosol delivery system 20 can lie against the second ramp region 14C such that a part of the aerosol delivery system 20 protrudes from the charging case 1. Although in the present example, the aerosol delivery system 20 may be moved (for example, slid) along the second ramp region 14C to move between the third and fourth positions such that the first end 20A of the system 20 projects (or projects further) out of the storage area 4, in other embodiments the first end 20A of the system 20 may project out of the storage area 4 when moved to the third position and thus may be gripped by a user for removal of the system 20, without the system 20 being moved along the second ramp region 14C (for example, slid) to a fourth position.

In some embodiments, one or more of the intermediate, second, third and/or fourth positions may be omitted such that the system 20 moves between the remaining positions.

In some embodiments, the first and second ramp regions 14A, 14C are angled towards each other.

In some embodiments, the first ramp region 14A is angled away from the port 5. In some embodiments, the second ramp region 14C is angled towards the port 5.

In some embodiments, the charging case 1 has a first surface 13 and wherein the recess 14 is configured such that the aerosol delivery system 20 can be moved to a position within the recess 14 wherein a part of the aerosol delivery system 20 protrudes from the first surface 13. In some embodiments, said part of the aerosol delivery system 20 is a first end 20A of the aerosol delivery system 20. In some embodiments, the part of the aerosol delivery system 20 protrudes from the first surface 13 when the aerosol delivery system 20 is moved to the fourth position (as shown in FIG. 20). In some embodiments, the part of the aerosol delivery system 20 protrudes from the first surface 13 when the aerosol delivery system 20 is moved to the third position (as shown in FIG. 19) and, optionally, the aerosol delivery system 20 may be moved to a fourth position (as shown in FIG. 20) wherein more of the aerosol delivery system 20 protrudes from the first surface 13 thereby further facilitating removal of the aerosol delivery system 20 from the storage area 4.

In some embodiments, the first surface 13 is a surface of the main body 2 of the charging case 1.

In some embodiments, the first surface 13 is generally planar. In some embodiments, the first surface 13 is a top surface 13, for example, a top surface 13 of the main body 2.

In some embodiments, the first surface 13 is generally parallel to the lid 3 when the lid 3 is in the closed position.

In some embodiments, the recess 14 is configured such that the aerosol delivery system 20 can rotate by at least 1 degree relative to the charging case 1 from the first position wherein the system 20 is connected to the port 5, to the second or third position wherein the system 20 enters the recess 14, and preferably, at least 1.5, 2 or 2.5 degrees. The greater the rotation of the aerosol delivery system 20 relative to the charging case 1 the easier it will be for the user to grip the first end 20A of the system 20 to remove the system 20 from the charging case 1.

In some embodiments, the central axis B-B of the aerosol delivery system 20 is parallel to the central axis A-A of the port 5 when the system 20 is connected to the port 5. In some embodiments, the central axis B-B of the aerosol delivery system 20 is at an angle P3 of at least 1 degree relative to the central axis A-A of the port 5 when the system 20 has entered the recess 14 and, preferably, an angle P3 of at least 1.5, 2 or 2.5 degrees (as shown in FIG. 19).

It should be recognized that movement of the aerosol delivery system 20 from the first position to the second, third and/or fourth position may in some examples not be purely rotational. For example, in one embodiment the aerosol delivery system 20 is slid linearly in the first direction Z1 from the first position to the intermediate position. The aerosol delivery system 20 may then rotate (in the direction shown by arrow ‘Z2’ in FIG. 18) into the recess 14, but optionally may also continue to move in the first direction ‘Z1’ such that the motion of the system 20 is not purely rotational (although there is still rotation of the system 20). The system 20 may then continue to rotate relative to the charging case 1 as the portion 20C at the second end 20B of the system 20 is moved along the intermediate region 14B to the third position. Movement of the system 20 from the third position to the fourth position may be a linear sliding motion, or the system 20 may also be rotated relative to the charging case 1 between the third and fourth positions.

Referring now to FIGS. 21 to 28, a charging case 1 according to a fourth embodiment is shown. The charging case 1 of the fourth embodiment is similar to the charging case 1 of the third embodiment of FIGS. 14 to 20 and has similar features. A difference is that the charging case 1 further comprises a ramp 12 that is generally similar to the ramp of the first embodiment of FIGS. 1 to 12. Another difference is that the first end 20A of the aerosol delivery system 20 is chamfered or rounded and the second end 20B of the aerosol delivery system 20 comprises a portion 20C that is chamfered or rounded.

The charging case 1 comprises a storage area 4 for receiving the aerosol delivery device 20. The port 5 is located at a first end 4A of the storage area 4.

The ramp 12 is located at a second end 4B of the storage area 4 that is distal to the port 5.

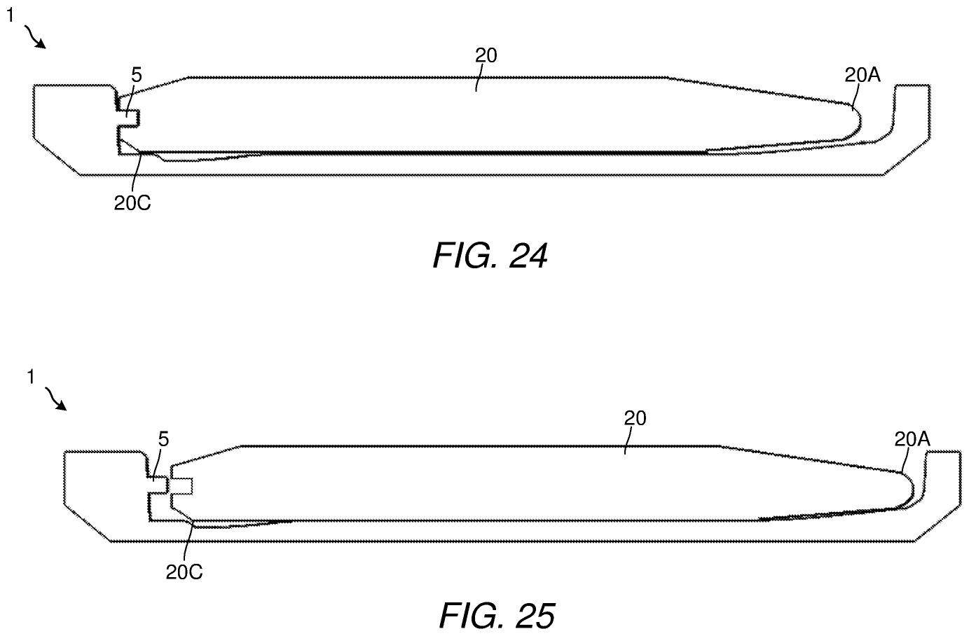

In the present example, the aerosol delivery system 20 is moved from a first position (shown in FIG. 24) to an intermediate position (shown in FIG. 25) in a first direction (shown by arrow ‘Z1’ in FIG. 24) to disconnect the aerosol delivery system 20 from the port 5. In the intermediate position, the first end 20A of the aerosol delivery system 20 is spaced from the ramp 12. However, in another embodiments (not shown), when the aerosol delivery system 20 is moved to the intermediate position (i.e. before the system 20 is rotated into the recess 14), the front end 20A of the system 20 abuts the ramp 20.

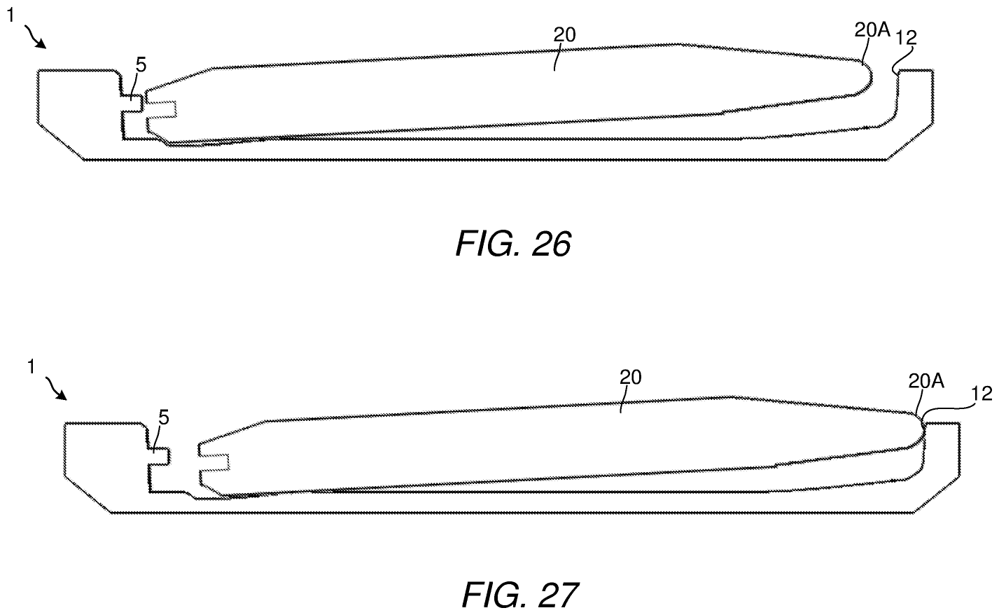

The second end 20B of the aerosol delivery system 20 is then pushed downwardly into the recess 14 by the user such that a portion 20C of the aerosol deliver system 20 at the second end 20B moves into the recess 14. This causes the aerosol delivery system 20 to rotate relative to the charging case 1 such that the first end 20A of the aerosol delivery system 20 moves upwardly although still being spaced from the ramp 12, wherein the first end 20A is lifted out of the storage area 4 and the aerosol delivery system 20 is moved to second position (shown in FIG. 26).

As with the third embodiment of FIGS. 14 to 20, the aerosol delivery system 20 of the fourth embodiment of FIGS. 21 to 28 comprises a recess 14 with a first ramp region 14A configured such that the portion 20C of the aerosol delivery system 20 can move along the first ramp region 14A in a direction away from the port 5 to move into the recess 14. The first ramp region 14A may therefore help to guide the aerosol delivery system 20 into the recess 14. In some embodiments, at least a portion of the first ramp region 14A extends at an angle P1 (see FIG. 23) of at least 5 degrees relative to the central axis A-A of the port 5 in a direction away from the port 5 and, preferably, at least 10, 12, 14, 16 or 18 degrees. The steeper the angle P1 of the first ramp region 14A, the larger the rotation of the aerosol delivery system 20 relative to the charging case 1 when the aerosol delivery system 20 slides down the first ramp region 14A. In some embodiments, the first ramp region 14A extends at a first angle P1 of at most 45 degrees relative to the central axis A-A of the port 5 in a direction away from the port 5 and, preferably, at most 30, 25, 20 or 18 degrees.

In the present example, the aerosol delivery system 20 is rotated into the recess 14 and moves along the first ramp region 14A until said portion 20C of the aerosol delivery system 20 abuts an intermediate region 14B at the bottom of the recess 14.

The system 20 is then slid in the first direction Z1 away from the port 5, along an intermediate portion 14B of the recess 14, to a third position, wherein the front end 20A of the system 2 abuts the ramp 12. As will be described below, a first end 20A of the aerosol delivery system 20 abuts at least a portion of the ramp 12 during removal of the system 20 from the charging case 1. Said portion of the ramp 12 extends at an angle (shown by ‘R1’ in FIG. 7) of at least 45 degrees relative to a central axis A-A of the port 5 in a direction away from the port 5, and preferably, at an angle R1 of at least 50, 60, 70, 75, 80, 85, 86 or 87 degrees. The steeper the angle R1, the greater the distance that the aerosol delivery system 20 will be lifted out of the storage area 4 for a given movement of the system 20 away from the port 5. In some embodiments, said portion of the ramp 12 extends at an angle R1 of at most 89 degrees relative to a central axis A-A of the port 5 in a direction away from the port 5, and preferably, at an angle R1 of at most 88 or 87 degrees. A shallower angle R1 of the ramp 12 makes it easier to push the aerosol delivery system 20 against the ramp 12.

In the present example, the first end 20A of the aerosol delivery system 20 comprises a rounded portion 20D that abuts said portion of the ramp 12 during removal of the system 20 from the charging case 1. The rounded portion 20D may reduce friction between the aerosol delivery system 20 and the charging case 1.

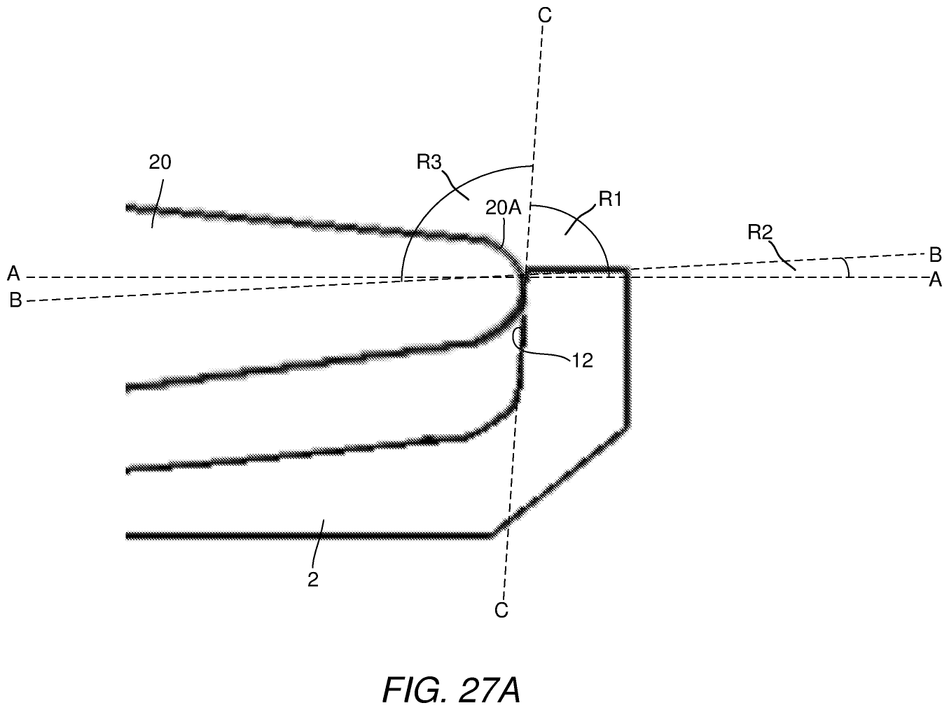

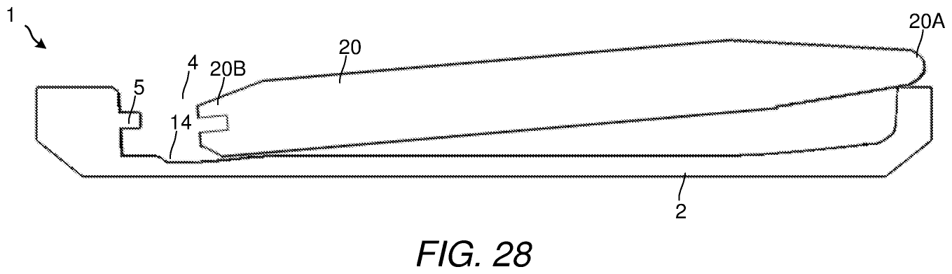

As with the third embodiment of FIGS. 14 to 20, the recess 14 aerosol delivery system 20 of the fourth embodiment of FIGS. 21 to 28 comprises a second ramp region 14C that is located at the opposite side of the intermediate regions 14B to the first ramp region 14A. The intermediate region 14B thus extends between the first and second ramp regions 14A, 14C. The second ramp region 14C is configured such that the aerosol delivery system 20 can move along the second ramp region 14C in a direction away from the port 5 such that the aerosol delivery system 20 moves from the third position (shown in FIG. 27) to a fourth position (shown in FIG. 28) wherein a part 20D of the aerosol delivery system 20 at the first end 20A of the aerosol delivery system 20 moves out of the charging case 1. In the present example, said portion 20C of the aerosol delivery system 20 moves along the second ramp region 14C between the second and third positions. However, in other embodiments a different portion of the aerosol delivery system 20 may move along the second ramp region 14C. The user may grip the first end 20A of the aerosol delivery system 20 when the aerosol delivery system 20 is moved to the third position and then remove the aerosol delivery system 20 from the storage area 4. Thus, the recess 14 facilitates easier removal of the aerosol delivery system 20.

In some embodiments, the first ramp region 14A, intermediate portion 14B and/or second ramp region 4C may be formed by one or more formations (not shown) instead of a planar surface(s). For example, in one embodiment (not shown) the charging case 1 comprises longitudinal ribs 6 (or a plurality of discrete protrusions) that extend between the first and second ends 4A, 4B of the storage area 4.

In some embodiments, at least a portion of the second ramp region 14C extends at a second angle P2 of at least 1 degrees relative to the central axis A-A of the port 5 in a direction towards the port 5 and, preferably, at least 1.5, 2 or 2.5 degrees. The larger the second angle P2 that the second ramp region 14C extends relative to the central axis A-A, the larger the angle that the aerosol delivery system 20 will be rotated relative to the central axis A-A of the port 5 when moved to the third position and thus the greater the extent that the first end 20A of the system 20 will be lifted out of the storage area 4.

In some embodiments, the second ramp region 14C extends at an angle P2 of at most 10 degrees relative to the central axis A-A of the port 5 in a direction towards the port 5 and, preferably, at most 8, 6, 4, 3 or 2.5 degrees.

The first and second ramp regions 14A, 14C and the intermediate region 14B may have any of the features described above in respect of the third embodiment of FIGS. 14 to 20.

As shown in FIGS. 27 and 27A, the second ramp region 14C is configured such that the aerosol delivery system 20 can lie against the second ramp region 14C such that the first end 20A of the aerosol delivery system 20 abuts a portion of the ramp 12. Said portion of the ramp 12 is at angle R1 relative to the central axis A-A of the port 5. Furthermore, the central axis B-B of the aerosol delivery system 20 is at an angle R2 relative to the central axis A-A of the aerosol delivery system 20, the is because the system 20 lies against the second ramp region 14C. In some embodiments, angle R2 corresponds to the angle P2 of the second ramp region 14C.

In some embodiments, angle R2 of the central axis B-B of the system 20 relative to the central axis A-A of the port 5 is at least 1 degrees relative to the central axis A-A of the port 5 in a direction towards the port 5 and, preferably, at least 1.5, 2 or 2.5 degrees. In some embodiments, angle R2 of the central axis B-B of the system 20 is at most 10 degrees relative to the central axis A-A of the port 5 in a direction towards the port 5 and, preferably, at most 8, 6, 4, 3 or 2.5 degrees.

The portion of the ramp 12 that the system 20 abuts in the third position is at an angle R1 relative to the central axis A-A of greater than 0 degrees and less than 90 degrees. Moreover, the central axis B-B of the system 20 is at an angle R2 relative to the central axis A-A of the port 5 of greater than 0 degrees. Therefore, the angle R3 between said portion of the ramp 12 (depicted by line C-C in FIG. 27A) and the central axis B-B of the system 20 can be calculated by Equation 1 below:

R3=(90−R1)+R2 [Equation 1]

In the present example, said portion of the ramp 12 is at an angle R1 of 87 degrees relative to the central axis A-A of the port 5. Furthermore, the central axis B-B of the system 20 is at an angle R2 of 2.5 degrees relative to the central axis A-A of the port 5. Therefore, the angle R3 between said portion of the ramp 12 and the central axis A-A of the port 5 is 5.5 degrees.

The larger the angle R3 between the ramp 12 and the central axis A-A of the port 5 (i.e. the horizontal plane of the storage area 4), the easier it is to move the front end 20A of the system 20 over the ramp 12 for removal from the charging case 1 (i.e. less force is required to move the system 20 over the ramp 12). To increase angle R3, the angle R1 of the ramp 12 can be decreased, but then this requires greater movement of the system 20 in the first direction Z1 and increases the size of the charging case 1 in the first direction Z1. Providing the recess 14 allows for the angle R3 to be increased because the system 20 is able to rotate relative to the charging case 1 such that the central axis B-B of the system 20 is at an angle R2 relative to the central axis A-A of the port 5.

In some embodiments, angle R3 is at least 1 degree and, preferably, is at least 2, 3, 4, 5 or 5.5 degrees.

In each of the first, second, third and fourth embodiments described above in relation to FIGS. 1 to 28 the formations 6, 6A, 6B, 6C, 6D are protrusions. For example, the protrusions may project outwardly from a surface 8 of the main body 2 and/or lid 3.

However, in an alternative embodiment (not shown) the formations may be depressions. For example, the formations may project inwardly into a surface 8 of the main body 2 and/or lid 3. The charging case 1 may comprise one or more such depression and/or one or more protrusion. The or each depression forms an air gap between the aerosol delivery system 20 and the charging case 1 and thus improves cooling of the aerosol delivery system 20 and reduces heat transfer between the aerosol delivery system 20 and the charging case 1. The or each depression also reduces the contact area between the charging case 1 and the aerosol delivery system 20 and thus reduces friction therebetween during connection and disconnection of the aerosol delivery system 20 with the port 5. In some embodiments (not shown), the depressions are in the form of one or more dimples.

In some embodiments, the protrusions 6, 6A, 6B, 6C, 6D are arranged such that at least one protrusion is in contact with the aerosol delivery system 20 at all times from when the aerosol delivery system 20 is first slid to disconnect from the port 5 until the aerosol delivery system 20 contacts the ramp 12 of the charging case 1. This helps to ensure that the aerosol delivery system 20 is constantly supported and that the sliding motion of the aerosol delivery system 20 is smooth.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A charging case for an aerosol provision system, the charging case comprising:
a charging connector configured to removably connect to a component of the aerosol provision system; and,
a ramp arranged such that when the component is moved in a direction away from the charging connector a part of the aerosol provision system moves along the ramp.

2. A charging case according to claim 1, comprising a storage area for receiving the aerosol provision system and, preferably, wherein the storage area is a cavity in the charging case.

3. A charging case according to claim 2, wherein the ramp is located at an end of the storage area that is distal to the charging connector.

4. A charging case according to claim 2, wherein the charging case has a first surface and the storage area extends into the first surface and, preferably, wherein the ramp extends to the first surface.

5. A charging case according to claim 1, wherein at least a portion of the ramp follows a substantially linear path.

6. A charging case according to claim 1, wherein at least a portion of the ramp follows a substantially curved path.

7. A charging case according to claim 1, wherein the ramp has a length of at least 0.6 mm and, preferably, at least 0.7 mm, 0.8 mm, 0.9 mm or 1 mm.

8. A charging case according to claim 1, wherein the charging case comprises a body and a lid, wherein the body or lid comprises the ramp.

9. A charging case according to claim 1, wherein said part of the aerosol delivery system is the component of the aerosol delivery system or is a further component of the aerosol delivery system.

10. A charging case according to claim 1, wherein the aerosol delivery system comprises an aerosol delivery device and, preferably, wherein the entire aerosol delivery device is moved in the direction away from the charging connector.

11. A charging case according to claim 1, wherein at least a portion of the ramp extends at an angle of at least 45 degrees relative to a central axis of the power connector in a direction away from the power connector, and preferably, at an angle of at least 50, 60, 70, 75, 80, 85, 86 or 87 degrees.

12. A charging case according to claim 1, wherein at least a portion of the ramp extends at an angle of at most 89 degrees relative to a central axis of the power connector in a direction away from the power connector, and preferably, at an angle of at most 88 or 87 degrees.

13. A charging case according to claim 1, wherein the ramp is arranged such that said part of the aerosol delivery system only moves along the ramp once the component has been disconnected from the power connector and, preferably, only when the component is spaced from the power connector.

14. A charging case according to claim 1, wherein the ramp is configured to lift said part of the aerosol delivery system out of the charging case when said part moves along the ramp.

15. A charging case according to claim 1, comprising one or more formations that are configured to space at least a portion of the aerosol provision system from the charging case to provide an air gap.

16. A charging case according to claim 15, wherein at least one formation is provided in proximity to the ramp such that said part of the aerosol delivery system moves from the at least one formation and on to the ramp.

17. A charging case according to claim 15, wherein the or each formation is arranged such that at least one formation is in contact with the aerosol delivery system at all times from when the component is disconnected from the power connector until said part of the aerosol delivery system contacts the ramp.

18. A charging case according to claim 1, wherein the ramp is arranged such that when the component is slid in the direction away from the charging connector the part of the aerosol provision system moves along the ramp.

19. A charging case for an aerosol provision system, the charging case comprising:
a charging connector configured to removably connect to a component of the aerosol provision system; and,
a recess arranged such that when the component has been disconnected from the charging connector a portion of the component can enter the recess to allow the component to rotate relative to the charging case.

20. A charging case according to claim 19, wherein the charging connector is arranged such that the component can be slid relative to the charging connector to disconnect from the charging connector.

21. A charging case according to claim 19, wherein the recess is arranged such that the component is moveable from a first position, wherein the component is connected to the charging connector, to a second position, wherein the component is disconnected from the charging connector and the component is rotated relative to the charging case to enter the recess.

22. A charging case according to claim 21, wherein the recess is arranged such that when the component is in the first position, said portion of the component is out of alignment with the recess in the axial direction of the power connector, and when the component is in the second position, said portion of the component is aligned with the recess in the axial direction of the power connector.

23. A charging case according to claim 19, wherein said portion of the component is disposed towards or at an end of the component.

24. A charging case according to claim 19, wherein the recess is configured such that the component can rotate by at least 1 degree when the component enters the recess and, preferably, can rotate by at least 1.5, 2 or 2.5 degrees.

25. A charging case according to claim 19, wherein the recess is configured such that the component rotates about an axis that is substantially perpendicular to the axial direction of the power connector to enter the recess.

26. A charging case according to claim 19, wherein the charging case has a first surface and wherein the recess is configured such that the component can be moved to a position within the recess wherein a part of the aerosol delivery system protrudes from the first surface and, preferably, the first surface is generally planar.

27. A charging case according to claim 19, wherein the recess is spaced from the power connector in the axial direction of the power connector and, preferably, is spaced from the power connector by a distance of less than 10 mm and, preferably, less than 9, 8, 7, 6 or 5 mm.

28. A charging case according to claim 19, wherein the recess comprises a first ramp region configured such that the component can move along the first ramp region in a direction away from the power connector to move into the recess.

29. A charging case according to claim 28, wherein at least a portion of the first ramp region extends at an angle of at least 5 degrees relative to the central axis of the power connector in a direction away from the power connector and, preferably, at least 10, 12, 14, 16 or 18 degrees.

30. A charging case according to claim 28, wherein at least a portion of the first ramp region follows a non-linear path and, preferably, is curved.

31. A charging case according to claim 19, wherein the recess comprises a second ramp region.

32. A charging case according to claim 31, wherein the second ramp region is configured such that the component can move along the second ramp region in a direction away from the power connector such that a part of the aerosol delivery device moves out of the charging case.

33. A charging case according to claim 31, wherein at least a portion of the second ramp region extends at a second angle of at least 1 degrees relative to the axial direction of the power connector in a direction towards the power connector and, preferably, at least 1.5, 2 or 2.5 degrees.

34. A charging case according to claim 31, wherein at least a portion of the second ramp region follows a substantially linear path.

35. A charging case according to claim 31, wherein the second ramp region is configured such that the component can lie against the second ramp region such that a part of the aerosol delivery device protrudes from the charging case.

36. A charging case according to claim 31, wherein the recess comprises a first ramp region configured such that the component can move along the first ramp region in a direction away from the power connector to move into the recess, wherein the recess comprises an intermediate region that extends between the first and second ramp regions and, preferably, the intermediate region follows a generally linear path and, preferably, the generally linear path is substantially parallel to the axial direction of the power connector.

37. A charging case according to claim 19, comprising a ramp arranged such that when the component is slid in a direction away from the charging connector a part of the aerosol provision system moves along the ramp.

38. A charging case according to claim 37, wherein the ramp has the features of any one of claims 1 to 18.

39. A charging case according to claim 37, wherein the recess comprises a second ramp region, and wherein the second ramp region is configured such that the component can lie against the second ramp region such that a part of the aerosol delivery device abuts the ramp.

40. A charging case according to claim 37, configured such that when the component is first disconnected from the power connector and rotated into the recess, the aerosol delivery system is spaced from the ramp, and wherein the component is then moved within the recess in a direction away from the power connector until the aerosol delivery system abuts the ramp.

41. A charging case according to claim 37, configured such that when the aerosol delivery system abuts the ramp, the central axis of the aerosol delivery system is at an angle of greater than 0 degrees and less than 90 degrees relative to the central axis of the power connector and, preferably, is at an angle of at least 1 degree, and preferably, at least 1.5, 2 or 2.5 degrees.

42. A charging case according to claim 37, configured such that when the aerosol delivery system abuts the ramp, the portion of the ramp that is abutted by the aerosol delivery system is at an angle of greater than 0 degrees and less than 90 degrees relative to the central axis of the power connector and, preferably, is at an angle of at least 45 degrees and preferably, at least 50, 60, 70, 75, 80, 85, 86 or 87 degrees.

43. A charging case according to claim 19, comprising one or more formations that are configured to space at least a portion of the aerosol provision system from the charging case to provide an air gap, and, preferably, wherein at least one formation is provided in the recess.

44. A charging case according to claim 19, wherein the charging case comprises a body and a lid, wherein the body or lid comprises the recess.

45. A charging case according to claim 19, comprising a storage area for receiving the aerosol provision system and, preferably, wherein the storage area is a cavity in the charging case.

46. A charging case according to claim 45, wherein the recess is located in the storage area.

47. A charging case according to claim any one of claim 19, wherein the recess is arranged such that the aerosol delivery system overlies the recess when the component is connected to the power connector.

48. A charging case according to claim 19, wherein said portion of the component is rounded or chamfered.

49. A charging case according to claim 1, wherein the aerosol provision system comprises a front end that is remote to the power connector when the component is connected to the power connector and, preferably, wherein the front end is rounded or chamfered.

50. A charging case according to claim 1, wherein the aerosol delivery system is an aerosol delivery device.

51. A charging case according to claim 1, further comprising the aerosol delivery system.

52. A charging case according to claim 1 wherein the aerosol delivery system is configured to receive a removable article comprising an aerosolisable material and, preferably, wherein said aerosolisable material is present on a substrate.

53. A charging case according to claim 1, wherein the aerosol delivery system in a non-combustible aerosol provision system and, preferably, comprises a tobacco heating system.

54. A kit of parts comprising a charging case according to claim 1, and an aerosol delivery system.

55. A kit of parts according to claim 54, further comprising an article for use in the aerosol delivery system and, preferably, wherein the article is a removable article comprising an aerosol generating material.
